(19) United States
(12) Patent Application Publication
(10) Pub. No.: US 2020/0351651 A1
(43) Pub. Date: Nov. 5, 2020

(54) METHOD AND APPARATUS FOR PROVIDING BUNDLE INFORMATION

(71) Applicant: Samsung Electronics Co., Ltd., Gyeonggi-do (KR)

(72) Inventors: Jonghoe KOO, Gyeonggi-do (KR); Duckey Lee, Gyeonggi-do (KR); Kangjin Yoon, Gyeonggi-do (KR); Taehyung Lim, Gyeonggi-do (KR)

(21) Appl. No.: 16/861,606

(22) Filed: Apr. 29, 2020

(30) Foreign Application Priority Data
May 3, 2019 (KR) 10-2019-0052385
Jul. 18, 2019 (KR) 10-2019-0087100

(51) Int. Cl. H04W 12/00; H04W 12/06; H04W 8/24

(52) U.S. Cl. CPC H04W 12/0023; H04W 8/245; H04W 12/06

(57) ABSTRACT

A method of providing bundle information is provided. The method includes obtaining a smart secure platform (SSP) credential, transmitting a request command including the obtained SSP credential and a request type for bundle information to a server, and when the SSP credential is verified at the server, receiving first bundle information or second bundle information from the server based on the request type. The first bundle information includes secondary platform bundle (SPB) metadata regarding the secondary bundle information.

### CROSS-REFERENCE TO RELATED APPLICATION(S)

This application is based on and claims priority under 35 U.S.C. § 119 to Korean Patent Application Nos. 10-2019-0052385, filed on May 3, 2019, and 10-2019-0087100, filed on Jul. 18, 2019, in the Korean Intellectual Property Office, the entire disclosures of which are incorporated herein by reference.

### BACKGROUND

### 1. Field

The present disclosure relates generally to a method and apparatus for providing bundle information, and more particularly, to a method and apparatus for generating, by a secondary platform bundle (SPB) server, bundle information and requesting bundle information by a smart secure platform (SSP) terminal in an SSP bundle download procedure.

### 2. Description of the Related Art

To meet the demand due to ever-increasing wireless data traffic after the commercialization of the 4^{th} generation (4G) communication system, there have been efforts to develop an advanced 5^{th} generation (5G) system or pre-5G communication system. For this reason, the 5G or pre-5G communication system is also called a beyond 4th-generation (4G) network communication system or post long term evolution (LTE) system. Implementation of the 5G communication system using ultra-frequency millimeter wave (mmWave) bands (e.g., 60 GHz bands) is considered to achieve higher data rates. To reduce propagation loss of radio waves and increase a transmission range of radio waves in the ultra-frequency bands, beamforming, massive multiple-input multiple-output (MIMO), full dimensional MIMO (FD-MIMO), array antenna, analog beamforming, and large-scale antenna techniques are under discussion. To improve system networks, technologies for advanced small cells, cloud radio access networks (RANs), ultra-dense networks, device to device (D2D) communication, wireless backhaul, moving networks, cooperative communication, coordinated multi-points (CoMP), reception-end interference cancellation and the like are also being developed in the 5G communication system. In addition, in the 5G system, an advanced coding modulation (ACM), e.g., hybrid frequency-shift keying (FSK) and quadrature amplitude modulation (QAM) modulation (FQAM), sliding window superposition coding (SWSC), and an advanced access technology, e.g., filter bank multi carrier (FBMC), non-orthogonal multiple access (NOMA), and sparse code multiple access (SCMA) are being developed.

In the meantime, the Internet is evolving into an Internet of things (IoT) network where distributed entities such as things send, receive and process information without human intervention. Internet of everything (IoE) technologies, in which a big data processing technology through connection with a cloud server, for example, are combined with the IoT technology, have also emerged. To implement IoT, various technologies, such as a sensing technology, a wired/wireless communication and network infrastructure, a service interfacing technology, and a security technology are required, and recently, even technologies for sensor network, machine to machine (M2M), machine type communication (MTC) for connection between things are being studied. Such an IoT environment may provide intelligent internet technology services that create a new value to human life by collecting and analyzing data generated among connected things. IoT may be applied to a variety of areas, such as smart home, smart buildings, smart cities, smart cars or connected cars, smart grid, health care, smart home appliances and advanced medical services through convergence and combination between existing information technologies (IT) and various industrial applications.

In this regard, various attempts to apply the 5G communication system to the IoT network are being made. For example, technologies regarding sensor network, M2M, MTC, etc., are implemented by the 5G communication technologies, such as beamforming, MIMO, and array antenna schemes, etc. Even application of a cloud RAN as the aforementioned big data processing technology may be said as an example of convergence of 5G and IoT technologies. With the development of the aforementioned technologies and mobile communication systems, it is possible to provide various services, and there is a need for a method to provide the services effectively.

### SUMMARY

The present disclosure has been made to address at least the disadvantages described above and to provide at least the advantages described below.

In accordance with an aspect of the present disclosure, a method of providing, by a terminal, bundle information is provided. The method includes obtaining an SSP credential, transmitting a request command including the obtained SSP credential and a request type for bundle information to a server, and when the SSP credential is verified at the server, receiving first bundle information or second bundle information from the server based on the request type. The first bundle information includes SPB metadata regarding the secondary bundle information.

In accordance with an aspect of the present disclosure, a method of providing, by a server, bundle information is provided. The method includes receiving a request command including an SSP credential of a terminal and a request type for bundle information from the terminal, identifying the request type for the bundle information from the request command, and when the SSP credential is verified, transmitting first bundle information or second bundle information to the terminal based on the identified request type. The first bundle information includes SPB metadata regarding the secondary bundle information.

In accordance with an aspect of the present disclosure, a terminal is provided. The terminal includes a transceiver and a processor configured to obtain an SSP credential, transmit, via transceiver, a request command including the obtained SSP credential and a request type for bundle information to a server, when the SSP credential is verified at the server, receive, via transceiver, first bundle information or second bundle information from the server based on the request type. The first bundle information includes SPB metadata regarding the secondary bundle information.

In accordance with an aspect of the present disclosure, a server is provided. The server includes a transceiver and a processor configured to receive, via the transceiver, a request command including an SSP credential of a terminal and a request type for bundle information from the terminal, identify the request type for the bundle information from the request command, and when the SSP credential is verified, transmit, via the transceiver, first bundle information or second bundle information to the terminal based on the identified request type. The first bundle information includes SPB metadata regarding the secondary bundle information.

### BRIEF DESCRIPTION OF THE DRAWINGS

The above and other aspects, features and advantages of certain embodiments of the disclosure will be more apparent from the following detailed description taken in conjunction with the accompanying drawings, in which:

FIG. 1 is a diagram an interface between internal components of an SSP terminal, according to an embodiment;

FIG. 2 is a diagram of internal and external components of an SSP terminal to download a bundle, according to an embodiment;

FIG. 3 is a diagram of a structure of first bundle information transmitted by a SPB manager to a local bundle assistant (LBA), according to an embodiment;

FIG. 4A is a sequence chart illustrating a method of requesting, by an SSP terminal, first and second bundle information from an SPB manager, according to an embodiment;

FIG. 4B is a diagram of a sequence chart illustrating a method of requesting, by an SSP terminal, second bundle information from an SPB manager without separately requesting first bundle information, according to an embodiment;

FIG. 5 is a diagram of a sequence chart illustrating a procedure of requesting, by an SSP terminal, second bundle information from an SPB manager after receiving first bundle information, according to an embodiment;

FIG. 6 is a diagram of a sequence chart illustrating a procedure of requesting, by an SSP terminal, second bundle information from an SPB manager after receiving first bundle information, according to an embodiment;

FIG. 7 is a diagram of a procedure of requesting, by an SSP terminal, second bundle information from an SPB manager after receiving first bundle information, according to an embodiment;

FIG. 8 is a diagram of a sequence chart illustrating a procedure of requesting, by an SSP terminal, second bundle information from an SPB manager after receiving first bundle information, according to an embodiment;

FIG. 9 is a diagram of a sequence chart illustrating a procedure of requesting, by an SSP terminal, second bundle information from an SPB manager after receiving first bundle information, according to an embodiment;

FIG. 10 is a flowchart of an operation of an SPB manager when the SPB manager receives a bundle information request function command in a bundle download procedure, according to an embodiment;

FIG. 11 is a flowchart of an operation of an SSP terminal, according to an embodiment;

FIG. 12 is a flowchart of an operation of an SPB server, according to an embodiment;

FIG. 13 is a diagram of an SSP terminal, according to an embodiment; and

FIG. 14 is a diagram of an SPB server, according to an embodiment.

### DETAILED DESCRIPTION

Embodiments of the disclosure will be described herein below with reference to the accompanying drawings. However, the embodiments of the disclosure are not limited to the specific embodiments and should be construed as including all modifications, changes, equivalent devices and methods, and/or alternative embodiments of the present disclosure. In the description of the drawings, similar reference numerals are used for similar elements.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may use corresponding components regardless of importance or an order and are used to distinguish a component from another without limiting the components. These terms may be used for the purpose of distinguishing one element from another element. For example, a first user device and a second user device indicates different user devices regardless of the order or importance. For example, a first element may be referred to as a second element without departing from the scope the disclosure, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a central processing unit (CPU) or an application processor (AP)) capable of performing a corresponding operation by executing one or more software programs stored in a memory device.

The terms used in describing the various embodiments of the disclosure are for the purpose of describing particular embodiments and are not intended to limit the disclosure. As used herein, the singular forms are intended to include the plural forms as well, unless the context clearly indicates otherwise. All of the terms used herein including technical or scientific terms have the same meanings as those generally understood by an ordinary skilled person in the related art unless they are defined otherwise. Terms defined in a generally used dictionary should be interpreted as having the same or similar meanings as the contextual meanings of the relevant technology and should not be interpreted as having ideal or exaggerated meanings unless they are clearly defined herein. According to circumstances, even the terms defined in this disclosure should not be interpreted as excluding the embodiments of the disclosure.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the disclosure may include at least one of an application-specific integrated circuit (ASIC) chip, a field-programmable gate array (FPGA), and a programmable-logic device for performing operations which has been known or are to be developed hereinafter.

An electronic device according to the disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a MPEG-1 audio layer-3 (MP3) player, a mobile medical device, a camera, and a wearable device. The wearable device may include at least one of an accessory type (e.g., a watch, a ring, a bracelet, an anklet, a necklace, a glasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit).

The electronic device may be a home appliance. The home appliance may include at least one of, for example, a television, a digital video disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

The electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment device, an electronic device for a ship (e.g., a navigation device for a ship, and a gyro-compass), avionics, security devices, an automotive head unit, a robot for home or industry, an automatic teller machine (ATM) in banks, point of sales (POS) devices in a shop, or an Internet of things (IoT) device (e.g., a light bulb, various sensors, electric or gas meter, a sprinkler device, a fire alarm, a thermostat, a streetlamp, a toaster, a sporting goods, a hot water tank, a heater, a boiler, etc.).

The electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device may be a combination of one or more of the aforementioned various devices. The electronic device may also be a flexible device. Further, the electronic device is not limited to the aforementioned devices, and may include an electronic device according to the development of new technology.

Hereinafter, an electronic device will be described with reference to the accompanying drawings. In the disclosure, the term “user” indicates a person using an electronic device or a device (e.g., an artificial intelligence electronic device) using an electronic device.

A secure element (SE) refers to a security module composed of a single chip that stores security information (e.g., a mobile communication network access key, user identification information such as an identity (ID) card/passport, credit card information, an encryption key, etc.) and that may be equipped with and may operate a control module (e.g., a network access control module such as a universal subscriber identity module (USIM), an encryption module, a key generation module, etc.) to use the stored security information. The SE may be used in various electronic devices (e.g., a smart phone, a tablet, a wearable device, an automobile, an IoT device, etc.), and may provide a security service (e.g., mobile communication network access, payment, user authentication, etc.) using the security information and the control module.

The SE may be classified into a universal integrated circuit card (UICC), an embedded secure element (eSE), and an SSP that is an integrated form of the UICC and eSE, and may be subdivided into a removable type, an embedded type, and an integrated type integrated into a particular device or system on chip (SOC) depending on a form that is connected to or installed on the electronic device.

The UICC is a smart card used while inserted to a mobile communication terminal, and also called a UICC card. The UICC may include an access control module to access a network of a mobile communication operator. Examples of the access control module may include a USIM, a subscriber identity module (SIM), an IP multimedia service identity module (ISIM), etc. A UICC including the USIM is often called a USIM card. Likewise, a UICC including the SIM is called a SIM card.

In the meantime, an SIM module may be equipped in the UICC card in a manufacturing stage, or an SIM module of a mobile communication service to be used at a time desired by the user may be downloaded onto the UICC card. The UICC card may also have a plurality of SIM modules downloaded and installed thereon, and may select and use one of the SIM modules. The UICC card may not or may be fixed to a terminal. A UICC fixed to a terminal for use is called an embedded UICC (eUICC), and in particular, a UICC embedded in a communication processor (CP), an AP, or an SoC having a single processor structure in which the CP and the AP are integrated is called an integrated UICC (iUICC). The eUICC and the iUICC may often be used while fixed to the terminal, and may refer to a UICC card capable of remotely downloading and selecting an SIM module.

In the disclosure, the UICC that is capable of remotely downloading and selecting an SIM module is commonly called the eUICC or iUICC. In other words, a UICC card among the UICC cards capable of remotely downloading and selecting an SIM module, which is not or is fixed to the terminal, is commonly called the eUICC or iUICC. Furthermore, downloaded SIM module information may be commonly called an eUICC profile, iUICC profile, or more simply, a profile.

The eSE refers to a fixed type SE that is used while fixed to an electronic device. The eSE may be commonly manufactured only for a manufacturer of the terminal at the request of the manufacturer to include an operating system and a framework. The eSE may remotely download and install a service control module in the form of an applet, and may be used for various security services, such as an electronic wallet, ticketing, an electronic passport, a digital key, etc. The SE in the form of a single chip attached to an electronic device, which is capable of remotely downloading and installing a service control module, is commonly called the eSE.

The smart secure platform may have functions of the UICC and the eSE supported in combination in a single chip, and may be simply called the SSP. The SSP may be divided into a removable SSP (rSSP), an embedded SSP (eSSP), and an integrated SSP (iSSP) embedded in an SoC. The SSP may include one primary platform (PP), and at least one secondary platform bundle (SPB). The PP may include at least one of a hardware platform or a low level operating system (LLOS), and the secondary platform bundle may include at least one of a high level operating system (HLOS) or an application driven on the HLOS. The secondary platform bundle may also be called an SPB or a bundle.

The bundle may access a resource, such as a CPU or a memory of the PP through a primary platform interface (PPI), and is thus driven on the PP. The bundle is equipped with a communication application such as a SIM, a USIM, an ISIM, etc., and further equipped with various applications such as an electronic wallet, ticketing, an electronic passport, a digital key, etc.

The SSP may be used for the use of the aforementioned UICC or eSE depending on the bundle remotely downloaded and installed, and a plurality of bundles may be installed in a single SSP and operated at the same time to be used both for the UICC and the eSE. In other words, when a bundle including a profile is operated, the bundle may be used for the UICC to access a network of a mobile communication operator. The UICC bundle may remotely download at least one profile, such as the eUICC or the iUICC, and may be operated by selecting at least one of the profiles. Furthermore, when a bundle including a service control module equipped with an application for providing e.g., electronic wallet, ticketing, electronic passport or digital key services is operated on the SSP, the SSP may be used for the eSE. Multiple service control modules may be installed and operated in an integrated manner or separately.

The SSP is a chip-type security module that may provide integrated support for the UICC and eSE functions in a single chip and that may be divided into the rSSP, the eSSP, and the iSSP. The SSP may download and install a bundle from an external bundle management server, i.e., an SPB manager, using an over the air (OTA) technology.

A method of downloading and installing a bundle using the OTA technology may be equally applied to the rSSP that may be removably inserted to a terminal, the eSSP that may be fixedly installed on the terminal, and the iSSP that may be integrated in an SoC installed on the terminal.

The terms UICC and SIM may be interchangeably used, and the terms eUICC and eSIM may also be interchangeably used.

The SPB as disclosed herein may be driven by using a resource of the PP on the PP of the SSP, and for example, the UICC bundle may refer to a software type package of an application, a file system, an authentication value, etc., which are stored in the existing UICC, and an operating system by which the application, file system, and authentication value is operated, e.g., HLOS. The SPB may be referred to as a bundle.

The USIM profile as disclosed herein may have the same meaning as a profile, or may refer to a software type package of information included in a USIM application in the profile.

In the disclosure, an operation of a terminal or an external server to enable a bundle may refer to an operation of changing a state of the profile to an enabled state to configure the terminal to receive a service provided by the bundle (e.g., a communication service through a communication operator, a credit card payment service, a user authentication service, etc.). The bundle in the enabled state may be represented as an enabled bundle. The enabled bundle may be stored in an internal or external storage space of the SSP in an encrypted state.

The enabled bundle as disclosed herein may be changed to an active state according to an external input of the bundle (e.g., a user input, push, a request of an application in the terminal, an authentication request from a communication operator, a PP management message, etc.) or an internal input of the bundle (e.g., timer, polling). The bundle in the activated state may be loaded onto a driving memory in the SSP from the internal or external storage space of the SSP, and may process and provide security information to the terminal using a security control device (i.e., secure CPU in the SSP).

An operation of a terminal or an external server to disable a bundle may refer to an operation of changing the state of the bundle to a disabled state to configure the terminal to not receive a service provided by the bundle. The bundle in the disabled state may be represented as a disabled bundle. The enabled bundle may be stored in an internal or external storage space of the SSP in an encrypted state.

The bundle management server as disclosed herein may provide a function to generate a bundle at the request of a service provider or another bundle management server, encrypt the generated bundle, create an instruction for remote bundle management, or encrypt the instruction for remote bundle management. The bundle management server providing the function may be represented as at least one of an SPB Manager, a remote bundle manager (RBM), an image delivery server (IDS), a subscription manager data preparation (SM-DP), SM-DP plus (SM-DP+), a manager bundler server, a managing SM-DP+, a bundle encryption server, a bundle generation server, a bundle provisioner (BP), a bundle provider), or a bundle provisioning credentials holder (BPC holder).

The bundle management server may serve to manage key and authentication settings to download, install, or update a bundle onto the SSP and remotely manage the state of the bundle. The bundle management server providing the function may be represented as at least one of the SPB manager, the RBM, the IDS, a subscription manager secure routing (SM-SR), a SM-SR plus (SM-SR+), an off-card entity of eUICC profile manager, a profile management credentials holder (PMC holder), or an eUICC manager (EM).

An open service broker server may be represented as at least one of the SPB manager, the RBM, a secondary platform bundle discovery sever (SPBDS), a bundle discovery sever (BDS), a subscription manager discovery service (SM-DS), a discovery service (DS), a Root SM-DS, or an alternative SM-DS. The open service broker server may receive a register event request (or event register request) from one or more bundle management servers or another open service broker server. Furthermore, one or more open service broker servers may be used in combination, in which case a first open service broker server may receive the register event request not only from the bundle management server but also a second open service broker server. The function of the open service broker server may be integrated into the bundle management server.

The term ‘terminal’ as herein used may also be referred to as a mobile station (MS), a user equipment (UE), a user terminal (UT), a wireless terminal, an access terminal (AT), a subscriber unit, a subscriber station (SS), a wireless device, a wireless communication device, a wireless transmit/receive unit (WTRU), a mobile node, a mobile, or other names. The terminal may include a cellular phone, a smart phone having a wireless communication function, a personal digital assistant (PDA) having a wireless communication function, a wireless modem, a portable computer having a wireless communication function, an image capturing device such as a camera with a wireless communication function, a gaming device having a wireless communication function, an appliance for music storage and play with a wireless communication function, an Internet appliance capable of wireless Internet access and browsing, or a portable unit or terminal having the functions in combination. Furthermore, the terminal may include an M2M terminal, or an MTC terminal/device, without being limited thereto. The terminal as herein used may also be referred to as an electronic device. An SSP capable of downloading and installing a bundle may be embedded in the electronic device. When the SSP is not embedded in the electronic device, the SSP physically separated from the electronic device may be inserted and connected to the electronic device. The SSP may be inserted to the electronic device in the form of a card. The electronic device may include a terminal, which may include the SSP that is capable of downloading and installing a bundle. The SSP may be embedded in the terminal, or separated from the terminal in which case the SSP may be inserted and connected to the terminal.

The terminal or the electronic device may include an LBA or local bundle manager (LBM), which is software or an application installed in the terminal or the electronic device to control the SSP. The LBA application may download a bundle onto the SSP or deliver a command to activate, deactivate, or delete a downloaded or installed bundle to the SSP.

The terminal or the electronic device may include a local profile assistant (LPA), which is software or an application installed in the terminal or the electronic device to control the eUICC. The LPA may be implemented in the LBA or may exist in the terminal as an application separate from the LBA. The LPA may be software or an application that may control an eSIM bundle of the terminal in which the SSP is embedded.

A bundle identifier may also be referred to a bundle family identifier (e.g., SPB family identifier), a bundle matching ID, a factor matching an event ID. The bundle identifier (SPB ID) may indicate a unique identifier of each bundle. The bundle family identifier (SPB family identifier) may indicate an identifier to identify a type of the bundle (e.g., a telecom bundle for accessing a network of a mobile communication company). The bundle identifier may be used with a value used by the bundle management server to index the bundle. The SSP ID may be a unique identifier of the SSP embedded in the terminal, and may be referred to as an sspID. Furthermore, it may correspond to a terminal ID when the terminal and the SSP chip are not separated as in an embodiment of the disclosure. It may also be referred to as a particular bundle ID (SPB ID) in the SSP. Specifically, it may be referred to as a bundle identifier of a manager bundle or a loader (i.e., an SPB loader (SPBL)) that installs another bundle on the SSP and manages activation, deactivation, or deletion of the bundle. The SSP may also have a plurality of SSP identifiers, which may have values derived from a single unique SSP identifier. The PP in the SSP may have a unique identifier called a PP identifier. The SSP identifier may be the PP identifier.

The loader (e.g., SPBL) may be referred to as a manager bundle for installing another bundle and managing activation, deactivation, or deletion of the bundle on the SSP. The LBA of the terminal or a remote server may install, activate, deactivate, or delete a particular bundle through the loader. The loader as herein used may also be referred to as an SSP.

In the disclosure, bundle downloading, remote bundle management, or other management/processing instructions for other bundles or the SSP may be collectively called an event. The event may be named a remote bundle provisioning (RBP) operation, or an event record, and each event may be referred to as data including at least one of a corresponding event identifier (event ID or eventID), a matching identifier (matching ID or matchingID), an address (FQDN, IP address, or URL) of a bundle management server or an open service broker server storing the event, or an identifier of each server. Bundle download may be interchangeably used with bundle installation. Furthermore, the event type may be used as a term indicating whether a particular event is bundle downloading, remote bundle management (e.g., deletion, activation, deactivation, replacement, update, etc.), or a command to manage/process other bundles or the SSP, and may be named an operation type or OperationType, an operation class or OperationClass, an event request type, an event class, an event request class, etc.

The LBM may be named bundle local management, local management, local management command, local command, LBM package, bundle local management package, local management package, local management command package, or local command package. The LBM may be used to change the state of a particular bundle (enabled, disabled, or deleted state) by software installed on the terminal, or update content of a particular bundle (e.g., bundle nickname, bundle metadata, etc.). The LBM may include one or more local management commands, in which case a target for each local management command may be the same or a different bundle.

A target bundle may refer to a bundle to be subject to a local management command or a remote management command.

A service provider may refer to a business entity that requests generation of a bundle by issuing a requirement to the bundle management server, and provides a service to the terminal through the bundle. It may refer to a mobile operator that provides a communication network access service through a bundle equipped with a communication application, and a business supporting system (BSS), an operational supporting system (OSS), a point of sale (POS) terminal, and other IT systems of the mobile operator may be collectively called the service provider. Furthermore, the service provider may not exclusively refer to a particular business entity but also refer to a group, association or consortium of one or more business entities or a representative representing the group or association.

Moreover, the service provider may be named an operator (OP or Op.), a bundle owner (BO), an image owner (IO), etc., and each service provider may be configured with or allocated at least one of a name or an object identifier (OID). When the service provider refers to a group or association or a representative of one or more business entities, the name or OID of any group or association may be shared by all business entities belonging to the group or association or partner business entities of the representative.

A network access application (NAA) is an application such as a USIM or ISIM stored in a UICC to access a network. The NAA may be a network access module.

A telecom bundle may be a bundle equipped with at least one NAA, or equipped with a function to remotely download and install at least one NAA. The telecom bundle may include a telecom bundle identifier indicating the telecom bundle.

An eSIM bundle may be a bundle that serves like an eUICC with eUICC OS operated therein to allow the UE to receive a profile. The eSIM bundle may include a telecom bundle identifier indicating the eSIM bundle.

An eSIM activation code is information for downloading a profile onto an eSIM terminal or SSP terminal. The eSIM activation code may include an address of an SM-DP+ to be accessed to download a profile, or an address of an SM-DS that may inform the address of the SM-DP+, and may include an activation code token value to be used as a matching identifier of a particular profile in the SM-DP+. When the eSIM activation code is input in the format of a QR code, ‘LPA’ may be attached as a prefix of data contained in the QR code.

An SSP activation code is information for downloading a bundle onto the SSP terminal. A terminal user may start a bundle download procedure by entering the SSP activation code to the LBA application of the SSP terminal. The SSP activation code may include the eSIM activation code.

The SSP activation code and the eSIM activation code may be collectively called an activation code. In general, the activation code as herein used may be any activation code before determination of whether the activation code is the SSP activation code or the eSIM activation code is made, and may be interpreted by the terminal as one of the SSP activation code or the eSIM activation code when entered to the terminal. When the eSIM activation code is included in the SSP activation code, the terminal may selectively perform downloading of a bundle or a profile.

A function called by the LBA may be one performed in an Si2 interface between the LBA and the SPB manager or an Si3 interface between the LBA and the SPB loader. The LBA may deliver a parameter to the SPB manager or the SPB loader via a particular function. Parameters delivered from the LBA by a particular function call may be referred to as a function instruction of the function, a function command, or a command. Upon reception of the function command, the SPB manager or the SPB loader may perform a particular operation according to the function command and then respond to the function command. The response may include parameters. The function command delivered from the Si3 interface and related operation, and a response to the function command may include several function commands and related operations, and a response to a sub-function command.

The function command through the Si2 may be delivered using a hypertext transfer protocol (HTTP). In particular, the delivery of the function command through the Si2 may be performed by an HTTP POST request message of the HTTP, and specifically, the command may be delivered in a body part of the HTTP POST request message.

A management organization object identifier may be an object identifier of an organization that manages a particular family identifier. There may be multiple agencies for a particular family identifier, each organization having an object identifier. The SSP terminal, the service provider, and the bundle management server may know which organization is a management entity of a bundle to be managed (e.g., downloaded) based on the management organization object identifier. Furthermore, they may understand which management entity manages a service to be provided by the bundle based on the object identifier.

First and second SSP information may be collectively called SSP information. The first SSP information is related to the SSP and may be non-encrypted data. The first SSP information may be interpreted by the LBA and the SPB manager without a particular decrypting process. The second SSP information is data obtained by encrypting the information related to the SSP.

The first bundle information may be metadata, or bundle metadata, secondary platform bundle's metadata. The first bundle information may include non-encrypted information readable to the LBA of the SSP terminal for a bundle to be downloaded by the service provider or the bundle management server (or SPB manager) onto the SSP terminal. The LBA of the SSP terminal may receive a consent from the user before receiving the second bundle information of the bundle, or determine whether the user's consent or intention is required for operation/management of the bundle after installation of the bundle. The first bundle information may be used for the LBA to show the user basic information of the bundle. After the bundle is installed, the first bundle information may be managed by the loader (e.g., SPBL) and updated by the service provider, the bundle management server (e.g., SPB manager), etc.

Encrypted second bundle may be a bound SPB image, a bound bundle or bound SPB, an encrypted SPB image, or an encrypted bundle or encrypted SPB. The second bundle information may include the first bundle information. The second bundle information contains information required to install a bundle, and the SSP may install the bundle onto the SSP by using data extracted from the second bundle information. Part of the second bundle information may be encrypted with a session key generated by the SSP and the SPB manager.

A bundle information request function may be a function requesting the first bundle information and the second bundle information of a bundle to be installed by the SSP terminal. An operation to request the first and second bundle information of the bundle may be performed by transmitting a bundle information request function command to the SPB manager. The bundle information request function command may be delivered by the SSP terminal to the SPB manager through the Si2 interface. The SSP terminal may request the first and second bundle information by delivering a certificate of the SSP, SSP information, an SSP credential including capabilities of the SSP, and the terminal information to the SPB manger. The bundle information request function may be distinguished by using a distinguisher or identifier included in the command. Furthermore, the bundle information request function may be distinguished by defining a different command for the bundle information request function.

In the description of the disclosure, when it is determined that a detailed description of related functions or configurations may unnecessarily obscure the subject matter of the disclosure, the detailed description will be omitted.

The following embodiments in particular are included in the disclosure: a method in which the SPB manager constructs the first bundle information of an SSP bundle, a method in which the SPB manager constructs the first bundle information based on SSP information and terminal information delivered by the SSP terminal, a method in which the SSP terminal constructs SSP information and terminal information to be used by the SPB manager to construct the first bundle information, a method in which the SSP terminal constructs SSP information and terminal information to be used by the SPB manager to construct the first bundle information by including a family identifier, and SSP information and terminal information defined by an object identifier of a management organization that manages the family identifier, a method in which the SSP terminal requests the first bundle information of a bundle to be downloaded from the SPB manager, a method in which the SSP terminal requests the second bundle information after requesting and receiving the first bundle information from the SPB manager, a method in which when the SSP terminal requests the second bundle information after requesting and receiving the first bundle information from the SPB manager, the SPB manager determines whether the SSP terminal is the one that previously receives the first bundle information, a method in which when the SSP terminal requests the second bundle information after requesting and receiving the first bundle information from the SPB manager, the SPB manager determines whether the SSP terminal is the one that previously receives the first bundle information by verifying a signature of a challenge value delivered by the SPB manager, and a method in which when the SSP terminal requests the second bundle information after requesting and receiving the first bundle information from the SPB manager, the SPB manager determines whether the SSP terminal is the one that previously receives the first bundle information by verifying a signature of a session identifier (or transaction identifier) generated by the SSP terminal.

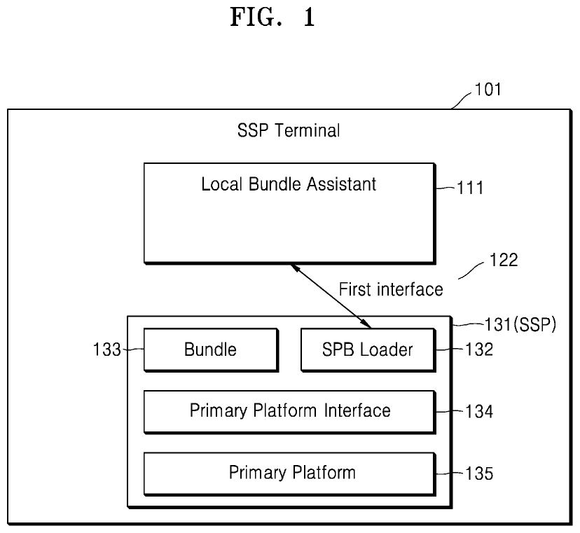

FIG. 1 is a diagram of an interface between internal components of an SSP terminal, according to an embodiment.

Referring to FIG. 1, an SSP terminal 101 may largely include an LBA 111 and an SSP 131, which are terminal software. Furthermore, the SSP terminal 101 may include a transceiver for transmitting or receiving signals to or from another terminal, a base station (BS), or a server, and a controller for controlling general operation of the SSP terminal 101. The controller may control operation of the SSP terminal. The controller may include at least one processor. The controller may control the SSP 131 through the LBA 111.

The SSP 131 may include an SPB (or bundle) 133, a PP 135, and a PPI 134. An SPB loader (or loader) 132 and an eSIM bundle 133 are types of bundle. The LBA 111 and the loader 132 exchanges a packet through a first interface 122, and the LBA 111 may perform the following operation through the first interface 122. The first interface 122 may be called a Si3 interface and may be configured to obtain first SSP information, obtain an SSP credential, and transmit a server credential, transmit bundle data to be installed on the SSP 131 to the loader 132, and manage (e.g., activate, deactivate, or delete) a bundle installed on the SSP 131.

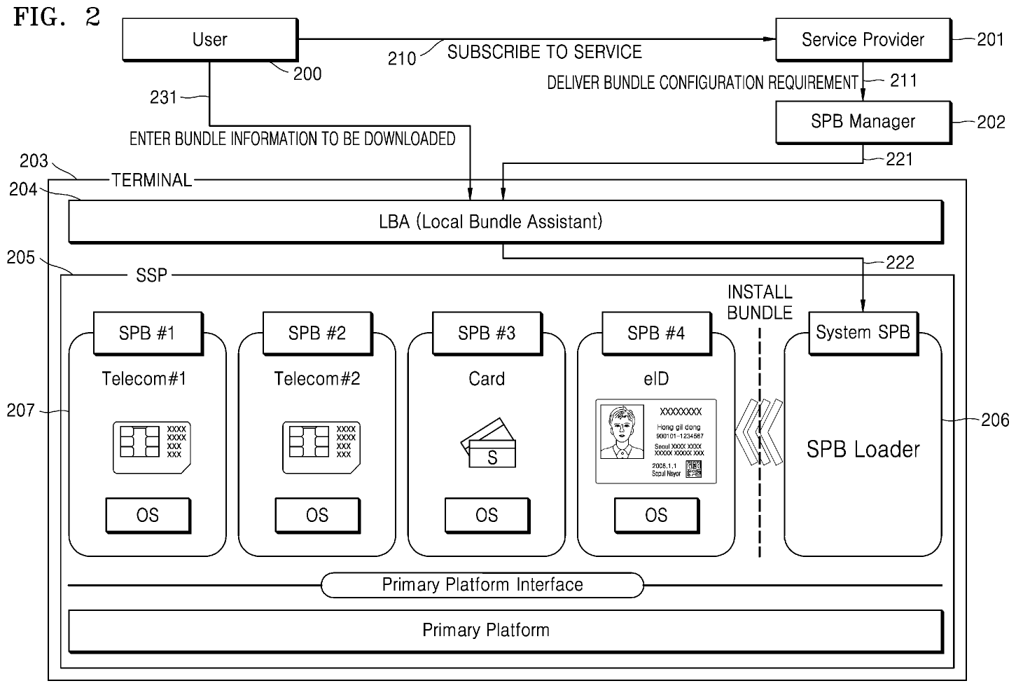

FIG. 2 is a diagram of internal and external components of an SSP terminal to download a bundle, according to an embodiment.

A terminal 203 may correspond to the SSP terminal 101 of FIG. 1. An LBA 204 may correspond to the LBA 111 of FIG. 1. An SPB loader 206 may correspond to the SPB loader 132 of FIG. 1. A bundle 207 may be an SPB. The terminal 203, LBA 204, and SPB loader 206 are described in connection with FIG. 1, so the description thereof will not be repeated.

Referring to FIG. 2, a user 200 may select and subscribe to a service (e.g., a data service via a mobile communication network) provided by a service provider 201 in a service subscription procedure 210. In this case, the user 200 may optionally deliver an identifier (SSP ID) of an SSP 205 to the service provider 201, the SSP 205 being installed on the terminal 203 in which to install a bundle to use a service provided by the service provider 201. In the service subscription procedure 210, the user 200 may receive an SSP activation code in the format of a QR code to install a bundle on the terminal of the user 200 from the service provider 201 after subscribing to the service. The SSP activation code received after the user 200 subscribes to a telecom service may include information to download a telecom bundle as well as an eSIM activation code to download an eSIM profile instead of the telecom bundle.

In a bundle configuration requirement delivery procedure 211, the service provider 201 and an SPB manager 202 may perform a bundle download preparation process. In the bundle configuration requirement delivery procedure 211, the service provider 201 may optionally deliver an identifier (SSP ID) of the SSP 205 in which to install a bundle to the SPB manager 202, and deliver at least one of a particular bundle identifier (SPB ID) to provide a service selected by the subscriber or a bundle family identifier (SPB family ID) to the SPB manager 202. The SPB manager 202 may select one of a bundle having the particular bundle identifier or a bundle having the bundle family identifier delivered to the SPB manager 202 in the bundle configuration requirement delivery procedure 211, and deliver the identifier of the selected bundle to the service provider 201. In the bundle configuration requirement delivery procedure 211, the service provider 201 or the SPB manager 202 may newly generate a bundle matching ID to distinguish the selected bundle. The bundle matching ID to distinguish a bundle may be called a code_M. Furthermore, the SPB manager 202 may manage the delivered SSP ID by linking the SSP identifier to the selected bundle. In the bundle configuration requirement delivery procedure 211, the SPB manager 202 may deliver a bundle management server address (i.e., an SPB manager address) from which to download the selected bundle to the service provider 201. The bundle management server address may be an address of a particular or any bundle management server in which a prepared bundle is stored, or an address of another bundle management server that may store and obtain download information (e.g., a server address) for the prepared bundle. In the bundle configuration requirement delivery procedure 211, the service provider 201 may also provide information about an eSIM profile matching the telecom bundle when requesting the SPB manager 202 to prepare the telecom bundle.

When some of the bundle configuration requirement delivery procedure 211 precede the service subscription procedure 210, the service provider 201 may deliver the download information for the prepared bundle to the user 200 in the service subscription procedure 210. At least one of a bundle management server address (e.g., SPB manager address) in which a bundle is prepared, a bundle matching ID of the prepared bundle, or a bundle family ID of the prepared bundle may be selectively delivered as the bundle download information.

Referring to FIG. 2, in an input procedure 231 of a bundle to be downloaded, the bundle download information may be delivered to the LBA 204 of the terminal 203. The bundle download information may include at least one of an address of a bundle management server (an SPB manager address) to be accessed by the LBA 204, a bundle distinguisher of a bundle prepared in the bundle configuration requirement delivery procedure 211, or a bundle family identifier of the prepared bundle. The bundle distinguisher may include at least one of a bundle matching ID generated in the bundle configuration requirement delivery procedure 211 or a bundle event ID. Furthermore, the bundle distinguisher may include the bundle family identifier of the prepared bundle. The bundle event ID may include at least one of a bundle matching ID of a bundle prepared in the bundle configuration requirement delivery procedure 211 or an address of a bundle management server. The user 200 may enter bundle download information to the LBA 204 by inputting an SSP activation code (e.g., by QR code scanning, direct text input, etc.). Furthermore, the bundle download information may be input to the LBA 204 by means of push input through an information providing server (not shown). Moreover, the bundle download information may be received by the LAB 204 accessing the information providing server that is pre-configured in the terminal 203.

Bundle downloading from the SPB manager 202 to the SSP 205 may be implemented by functions and operations performed in an interface between the SPB manger 202 and the LBA 204 and an interface 222 between the LBA 204 and the SPB loader 206. The interface 222 between the LBA 204 and the SPB loader 206 may correspond to the first interface 122 of FIG. 1. The interface 222 between the LBA 204 and the SPB loader 206 may be called the Si3 interface.

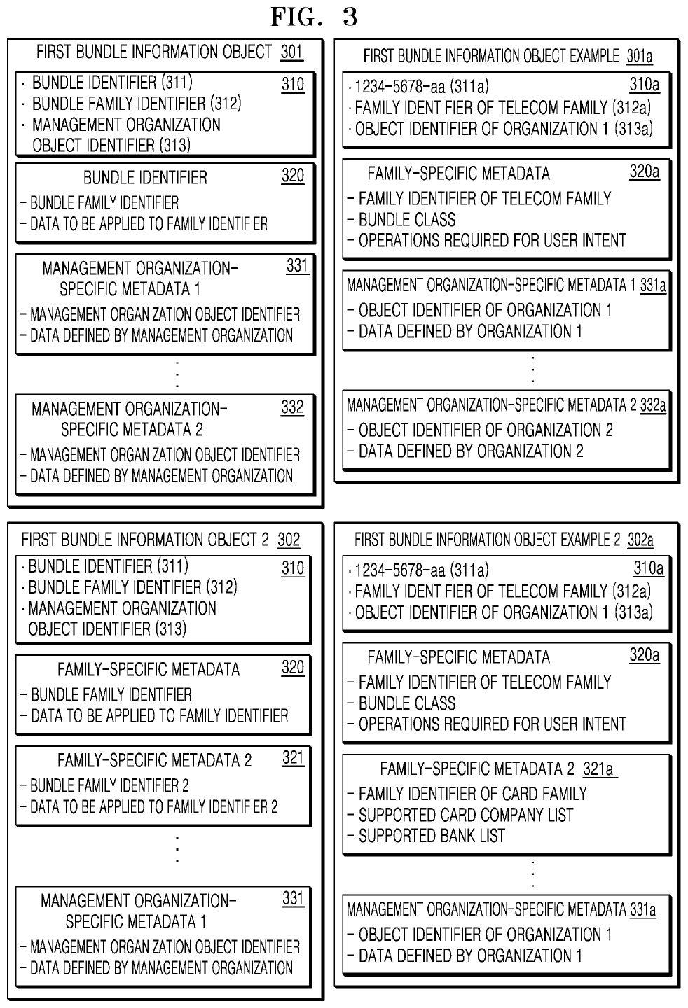

FIG. 3 is a diagram of a structure of first bundle information delivered by an SPB manager to an LBA, according to an embodiment.

A first bundle information object 301 may include a first bundle information basic field 310, a family-specific metadata 320, and a management organization-specific metadata 331 and 332. The first bundle information object 301 may include a plurality of management organization-specific metadata items.

The first bundle information basic field 310 may include a bundle identifier 311, and a bundle family identifier 312, a management organization object identifier 313. The bundle identifier 311 may be an SPB identifier corresponding to the first bundle information. The bundle family identifier 312 may be an identifier of a family that an SPB corresponding to the first bundle information belongs to. The management organization-specific object identifier 313 may be an object identifier of an organization that manages the family identifier of the SPB corresponding to the first bundle information. The first bundle information basic field 310 may include a plurality of management organization object identifiers 313. When the first bundle information basic field 310 includes the plurality of management organization object identifiers 313, the plurality of management organization object identifiers 313 may be arranged based on preferences, or the most preferred one of the plurality of management organization object identifiers may be designated. The first bundle information basic field 310 may be used to verify whether a certificate of the loader used by the SPB loader (or loader) 206 of the SSP terminal in the bundle installation procedure and a certificate of the SPB manager have been correctly used.

In FIG. 3, the family-specific metadata 320 may include the bundle family identifier 312. The family-specific metadata 320 may include settings, parameters, and functions to be shared by bundles having the family-specific identifier.

The management organization-specific metadata 331 and 332 in FIG. 3 may include a management organization object identifier. The management organization object identifier included in the management organization-specific metadata may have a different value from the management organization object identifier 313 included in the first bundle information basic field 310. When the management organization object identifier 313 in the first bundle information 301 is a first management organization, the first bundle information 301 may include management organization-specific metadata defined by a second management organization that manages the same family identifier as for the first management organization. The first bundle information 301 may not include the management organization-specific metadata.

A first bundle information example 301a of FIG. 3 is an example that conforms to the structure of the first bundle information object 301. The first bundle information basic field 310a of the first bundle information example 301a may include a bundle identifier 311a having a value of ‘1234-5678-aa’, a bundle family identifier 312a having a family identifier value of the telecom family, and a management organization object identifier 313a having an object identifier of an organization 1.

The first bundle information example 301a may include a family-specific metadata 320a, and the family-specific metadata 320a may include such a value as the bundle family identifier 312a. The family-specific metadata 320a may include settings, parameters, and functions to be shared by bundles having the family-specific identifier 312a. In particular, the bundle family identifier 312a of the first bundle information example 301a is a family identifier of the telecom family, so the family-specific metadata 320a may include the family identifier of the telecom family and include settings, parameters, and functions to be shared by telecom family bundles.

The first bundle information example 301a may include a management organization-specific metadata 331a or 332a defined by the respective organizations that manage the bundle family identifier 310a. The management organization-specific metadata 331a or 332a may include an object identifier of the management organization and settings, parameters, and functions defined by the organization. The family-specific metadata 320a needs to be defined for the bundle family identifier 312a of the first bundle information basic field 310a. Although the management organization-specific metadata 331a or 332a needs to be defined for the bundle family identifier 312a, it does not need to include a management organization object identifier 313a included in the first bundle information basic field 310a.

The first bundle information may include a plurality of family-specific metadata items 320 and 321 as in a first bundle information object 2 302. The first bundle information object 2 302 may also include a plurality of management organization-specific metadata items 332. A first bundle information example 2 302a is an example of the first bundle information including a plurality of family-specific metadata items. Like the first bundle information example 301a, the first bundle information example 2 302a is a family identifier of a telecom family, and a management organization object identifier 313a includes an object identifier of an organization 1. The first bundle information example 302a may include two family-specific metadata items 320a and 321a, among which family-specific metadata 1 320a may include the bundle family identifier 312a of the first bundle information basic field 310a in the first bundle information example 2 302a. Furthermore, the family-specific metadata 1 320a may include data to be applied to the bundle family identifier 312a. The family-specific metadata 2 321a may include a different family identifier from the bundle family identifier 312a. The family-specific metadata 2 321a may include a different value from the bundle family identifier 312a, and include data for the different family identifier. The family-specific metadata 2 321a is not data for the bundle family identifier 312a of the first bundle information example 2 302a, but may be used as needed by the SSP terminal and the SSP.

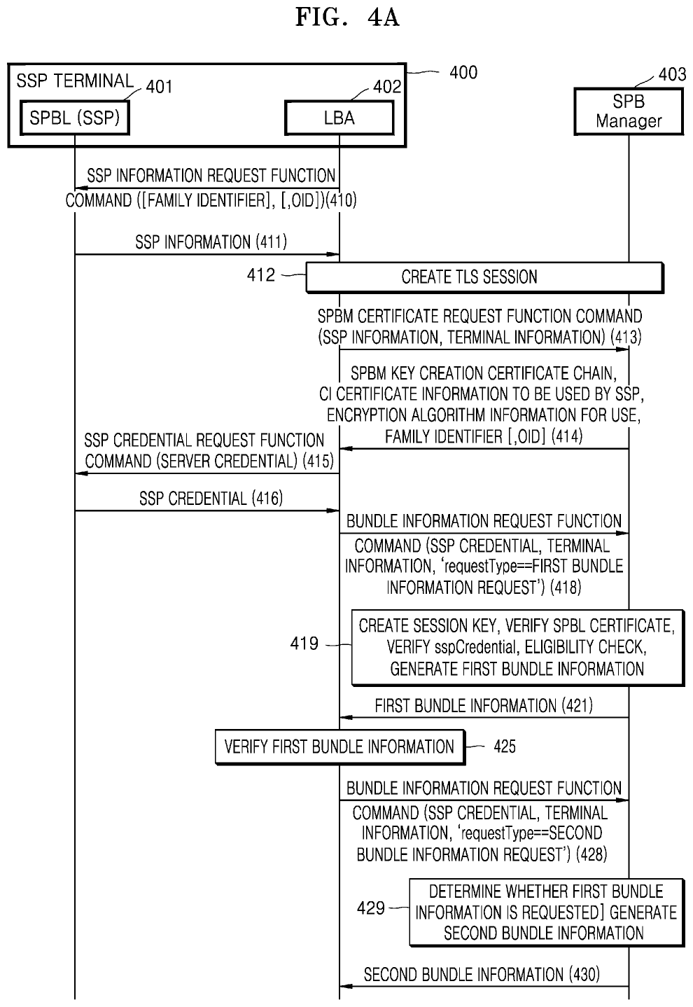

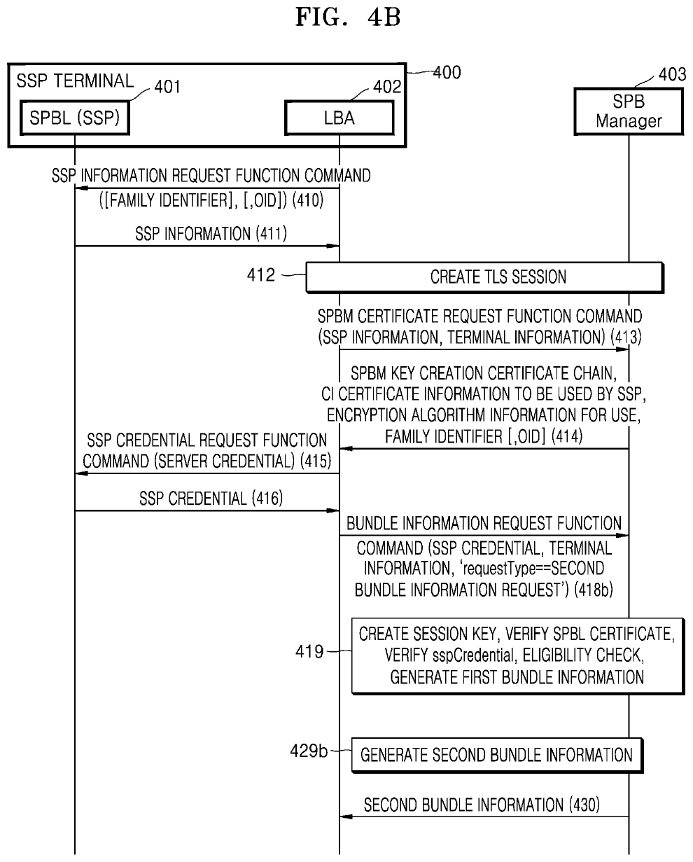

FIG. 4A is a diagram of a sequence chart illustrating a method of requesting, by an SSP terminal, first and second bundle information from an SPB manager, according to an embodiment.

At step 410, an LBA 402 of an SSP terminal 400 sends a loader in the SSP (i.e., SPB loader 401) a function that requests SSP information to install a bundle on the SSP. An SSP information requesting function command may include a family identifier of the bundle to be installed. The SSP information requesting function command may also include an object identifier of an organization that manages the family identifier of the bundle to be installed.

At step 411, upon reception of the SSP information requesting function command, the loader 401 may generate and send first SSP information to the LBA 402. The first SSP information may include a certificate CI information list to be used by the loader 401 and an SPB manager 403, an encryption algorithm identifier list to be used in a bundle downloading procedure, and a key exchange algorithm identifier list for generating a session key. The first SSP information may include the certificate CI information list to be used by the loader 401 and an SPB manager 403, the encryption algorithm identifier list and the key exchange algorithm identifier list, to download a bundle having a particular family identifier and a management organization object identifier of a particular management organization that manages the particular family identifier. The first SSP information may include SSP version information.

Furthermore, in FIG. 4A, in between steps 410 and 411, the loader 401 may notify the LBA 402 that step 410 is completed, and the LBA 402 may deliver a command to request the loader 401 to perform step 411.

At step 412, the LBA 402 may create a transport layer security (TLS) session with the SPB manager 403 from which the LBA 402 requests to download a bundle.

At step 413, the LBA 402 calls an SPBM certificate request function from the SPB manager 403. When calling the function, the LBA 402 may deliver the first SSP information and first terminal information received from the loader 401 at step 411 in the SPBM certificate request function command to the SPB manager 403. The terminal information may be configured to include one of version information of the LBA 402, terminal information defined for each family identifier, terminal information defined for each organization that manages a particular family identifier.

At step 413, the SPB manager 403 called for the SPBM certificate request function may perform at least one of the following steps: (1) performing eligibility check: check whether the SSP terminal may be supported by the SPB manager by verifying the version of the LBA and SPBL, (2) selecting a family identifier of a bundle, (3) selecting an object identifier of a management organization that manages the family identifier of the bundle, (4) selecting an SPBM key generation certificate (CERT.SPBM.KA) and a certificate chain to verify the SPBM key generation certificate, (5) selecting CI information of a certificate to be used by the SSP, and (6) selecting encryption algorithm information to be used by the SSP for data encryption.

At step 414, the SPB manager 403 may respond with at least one of an SPBM key creation certificate and certificate chain, CI information of a certificate to be used by the SSP, encryption algorithm information to be used by the SSP, or a family identifier of a bundle. The SPB manager 403 may also respond with an object identifier of an organization that manages the family identifier.

At step 415, the LBA 401 may call an SSP credential request function from the loader 401 upon reception of the response from the SPB manager 403. When calling the SSP credential request function, the LBA 402 may deliver a server credential in the function command. The server credential may include at least one of the following, (1) bundle code matching information (matching ID or CODE_M), (2) a bundle family identifier, (3) an SPBM key generation certificate (CERT.SPBM.KA) and a certificate chain to verify the SPBM key generation certificate, (4) C information of a certificate for signature to be used by the SSP, or (5) encryption algorithm information to be used by the SSP.

Furthermore, in addition to the aforementioned information, the server credential may optionally include bundle code matching supplementary information (challenege_S).

Upon reception of the SSP credential request function command, the loader 401 may create an SSP credential based on the received server credential. A step to create the SSP credential may include the following: (1) verification of the SPBM key creation certificate (CERT.SPBM.KA), (2) selection of a certificate for SPBL signature based on the CI information of the certificate to be used by the SSP, (3) creation of an SPBL ephemeral key pair, (4) creation of ID_TRANSAC to be used as a session ID, (5) creation of a first session key (session key 1) with a public key included in the SPBM key creation certificate and a private key of the SPBL ephemeral key, (6) creation of sspImageSessionToken including the SPBL ephemeral key, and creation of sspImageSessionTokenSignature obtained by signing the sspImageSessionToken with a secret key (SK.SPBL.DS) corresponding to an SPBL certificate for signature (CERT.SPBL.DS), and (7) generation of second SSP information.

The second SSP information may include a PP identifier. The second SSP information may include SSP information defined for a family identifier to be downloaded, and SSP information defined for each organization that manages the family identifier. The second SSP information may include, for a family identifier of a bundle to be downloaded, management organization-specific SSP information defined respectively by organizations that manage the bundle or service with the family identifier or management organizations (or custodians) that manage the family identifier. The second SSP information may include a plurality of pieces of management organization-specific SSP information. The second SSP information may include family-specific SSP information available in common to the management organizations for the family identifier of the bundle to be downloaded. The family-specific SSP information may include a family identifier, and a list of management organizations supported by the SSP equipped in the terminal for the family identifier. The list of management organizations supported by the SSP may be a list of object identifiers of the management organizations supported by the SSP for the family identifier. The phrase ‘the SSP supporting a management organization’ may mean that the SSP may be able to interpret the meaning of SSP settings, parameters, bundle operation/management, etc., defined by the management organization and determine whether to support the following: (1) creation of sspToken including bundle code matching information (matching ID, code_M), bundle code matching supplementary information (challege_S), the second SSP information generated as described above, and creation of sspTokenSignature obtained by signing the sspToken with a private key corresponding to the certificate (CERT.SPBL.DS) for SPBL signature, (2) first encryption information (M-SSP) and first integrity check information (H-SSP) may be generated by encrypting the certificate for SPBL signature (CERT.SPBL.DS), SspToken, and SspTokenSignature with the first session key created as described above, and second encryption information (M-SSP2) and second integrity check information (H-SSP2) may be created by encrypting the created SspToken and SspTokenSignature separately from the certificate for SPBL signature, and (3) creation of an SSP credential including a certificate chain to be used by the SPB manager to verify the certificate for SPBL signature, the sspmageSeesionToken, the sspImageSessionTokenSignature, the sspToken, the sspTokenSignature, the first encryption information (M-SSP), and the first integrity check information (H-SSP). The SSP credential may include the second encryption information (M-SSP2) and the second integrity check information (H-SSP2).

At step 416, the loader 401 may transmit the SSP credential to the LBA 402 in response to the SSP credential request function. When there is an error occurring in a step during the SSP credential creation procedure, an error message may be responded to terminate the procedure.

Furthermore, in FIG. 4A, in between steps 415 and 416, the loader 401 may notify the LBA 402 that step 415 is completed, and the LBA 402 may deliver a command to request the loader 401 to perform step 416.

At step 418, upon reception of the SSP credential from the loader 401, the LBA 402 may call a bundle information request function from the SPB manager 403. In calling the bundle information request function, the LBA 402 may deliver a bundle information request function command including the following to the SPB manager 403: (1) the SSP credential received from the loader 401, (2) terminal information (the terminal information may include LBA version information, family-specific terminal information defined for a family identifier, and management organization-specific terminal information defined by an organization that manages a particular family identifier (the family-specific terminal information may include a family identifier, representing itself as terminal information for the family identifier. The family-specific terminal information may include information, parameters, settings, and functions in relation to the family identifier. The family-specific terminal information may include a list of management organizations supported by the SSP terminal. The list of management organizations supported by the SSP terminal may be a list of object identifiers of the management organizations supported by the SSP terminal for the family identifier. The phrase ‘the SSP terminal supporting a management organization’ may mean that the SSP terminal may be able to interpret the meaning of terminal information, terminal settings, parameters, and terminal functions defined by the management organization and determine whether to support them)), and (3) requestType representing information requested by the SSP terminal from the SPB manager 403.

The requestType may be represented by one of various types including Type-A requesting the second bundle information from the SSP, Type-B requesting only the first bundle information, and Type-C requesting the second bundle information after requesting the first bundle information. The requestType may be used to define an operation in addition to the aforementioned steps, and may extend the step by using Type-D, Type-E, etc. For a method of distinguishing a type based on the requestType, it is possible not to send the requestType to indicate the most basic operation type. When the operation of Type-A is a basic operation, the SPB manager 403 may recognize type-A when there is no requestType in the bundle information request function command, and may perform another operation depending on a value corresponding to the requestType when there is the requestType in the bundle information request function command. Furthermore, information relating to the requestType may not be included in the bundle information requestfunction command, and a type is distinguished by defining a particular bundle information request function command corresponding to the type.

An occasion when the requestType of the bundle information request function command includes one of Type-A (a type requesting the second bundle information) or Type-B (a type requesting only the first bundle information) while the LBA 402 calls the bundle information request function may correspond to step 418. Furthermore, even an occasion when a particular bundle information request command not including information about the requestType but corresponding to Type-A and Type-B may correspond to step 418. Step 418 of FIG. 4A shows an occasion when the requestType corresponds to Type-B (a type requesting only the first bundle information).

At step 419, upon reception of an SSP credential, terminal information, and requestType having Type-A or Type-B, the SPB manager 403 may perform at least one of the following steps based on the received SSP credential and terminal information. Furthermore, at step 419, even when a particular bundle request function command not including the requestType but corresponding to Type-A or Type-B is received, at least one of the following steps may be performed: (1) determining whether the requestType is Type-A or Type-B, or whether the bundle request function command corresponds to Type-A or Type-B, (2) determining whether a bundle owned by the SPB manager 403 is compatible with the SSP terminal 400 based on the second SSP information, (3) creating a first session key using a public key (ePK. SPBM. KA) of an SPBL ephemeral key, and a private key (eSK. SPBM. KA) paired with the public key (ePK. SPBM. KA) of an SPBM key creation certificate, (4) decoding M-SSP using the first session key, (5) verifying a certificate for SPBL signature obtained by decoding the M-SSP and an SPBL certificate chain in the SSP credential (the certificate may be verified by utilizing the CI information of a certificate to be used by the SSP, which is transmitted at step 413), (6) verifying sspToken obtained by decoding the M-SSP and sspTokenSignature, a signature of the sspToken, with the SPBL certificate, (7) verifying sspImageSessionToken and sspImageSessionTokenSignature, a signature of the sspImageSessionToken, for the SPBL certificate, (8) storing a value of ID_TRANSAC in sspImageSessionToken, (9) determining whether a bundle corresponding to CODE_M that exists in the sspToken is stored, (10) determining whether it is possible for a bundle corresponding to CODE_M that exists in the sspToken to be installed on the SSP terminal (the determination may be performed based on a PP identifier included in the second SSP information, family-specific SSP information defined for a family identifier to be downloaded, and management organization-specific SSP information defined for each organization that manages the family identifier), and (11) generating the first bundle information of the bundle corresponding to the CODE_M may be created, or the first bundle information already ready may be prepared.

Generation of the first bundle information of the bundle may include the following procedure: (1) setting a bundle identifier 311 of FIG. 3, (2) setting a bundle family identifier 312 of FIG. 3 (the set family identifier may be equal to a family identifier included in the response from the SPB manager 403 at step 414), (3) setting a management organization object identifier 310 (the set management organization object identifier may include a management organization object identifier that the SPB manager 403 optionally includes in the response at step 414), (4) adding family-specific metadata 320 of FIG. 3 to the first bundle information (the family-specific metadata may include the set bundle family identifier. The family-specific metadata may include settings, parameters, information relating to bundle operation/management defined for the set bundle family identifier), and (5) adding management organization-specific metadata 331 of FIG. 3 to the first bundle information.

The first bundle information may include a plurality of management organization-specific metadata items. The SPB manager 403 may add the management organization-specific metadata to the first bundle information based on the family-specific SSP information and the management organization-specific SSP information included in the second SSP information. The SPB manager 403 may add management organization-specific metadata defined by a management organization included in a list of management organizations supported by the SSP included in the family-specific SSP information delivered by the SSP terminal to the first bundle information. The SPB manager 403 may add management organization-specific metadata defined by a management organization not supported by the SSP terminal to the first bundle information.

At step 419, after generating the first bundle information, the SPB manager 403 may record the generation of the first bundle information and manage the first bundle information. The SPB manager 403 may connect the first bundle information to all or partial information of the SSP credential delivered by the LBA 402 and then manage the first bundle. The SPB manager 403 may connect the first bundle information to the entire SSP credential or some element (e.g., Transaction Id) of the SSP credential, and then manage the first bundle information. Such recording and management performed by the SPB manager 403 may be used in a method of checking whether the first bundle information is requested which is part of the operation performed at step 429, by way of the SSP credential of the bundle information request function command, when the bundle information request function command requesting the second bundle information is received from the same terminal in the future.

At step 421, the SPB manager 403 may respond to the bundle information request function of step 418 with the first bundle information. When the bundle information request function command corresponding to Type-A is received at step 418, step 421 may be skipped.

At step 425, upon reception of the first bundle information, the LBA 402 may perform verification of the first bundle information. The operation to verify the first bundle information may include the following procedure: (1) the LBA 402 may verify whether a family identifier 311 of FIG. 3 included in the received first bundle information has a valid value (a method of verifying the family identifier may include a procedure of determining whether a family identifier included in the first bundle information is equal to a family identifier included in input information when the LBA performs bundle downloading based on the input information to the LBA in the bundle information input procedure 231 of FIG. 2 and there is the bundle family identifier in the input information. Furthermore, the method of verifying the family identifier may include a procedure of determining whether a family identifier included in a response to the SPBM certificate request function command at step 414 is equal to a family identifier included in the first bundle information), (2) the LBA 402 may verify whether a management organization object identifier 313 of FIG. 3 included in the received first bundle information has a valid value (a method of confirming validity of the management organization object identifier may include, when bundle downloading is performed based on information input to the LBA in the bundle information input procedure 231 of FIG. 2 and there is a management organization object identifier included in the information input to the LBA, determining whether management organization object identifier has the same value as the management organization object identifier of the received first bundle information. Furthermore, the method of confirming validity of the management organization object identifier may include a procedure of determining whether the management organization object identifier included in a response to the SPBM certificate request function command at step 414 is equal to the management organization object identifier included in the first bundle information), and (3) the LBA 402 may check terminal settings, parameters, and functions included in the family-specific metadata in the received first bundle information.

At step 428, the LBA 402 may deliver a bundle information function command whose requestType is Type-C (a type requesting the second bundle information after requesting the first bundle information) to the SPB manger 403. Furthermore, at step 428, the LBA 402 may deliver a particular bundle request function command not including the requestType but corresponding to Type-C to the SPB manager 403.

Upon receiving a bundle request function command whose requestType is Type-C (a type requesting the second bundle information after requesting the first bundle information) or a particular bundle request function command corresponding to Type-C, the SPB manager 403 may perform step 429. At step 429, the SPB manager 403 may perform a procedure of determining whether the first bundle information is requested and an operation of generating the second bundle information.

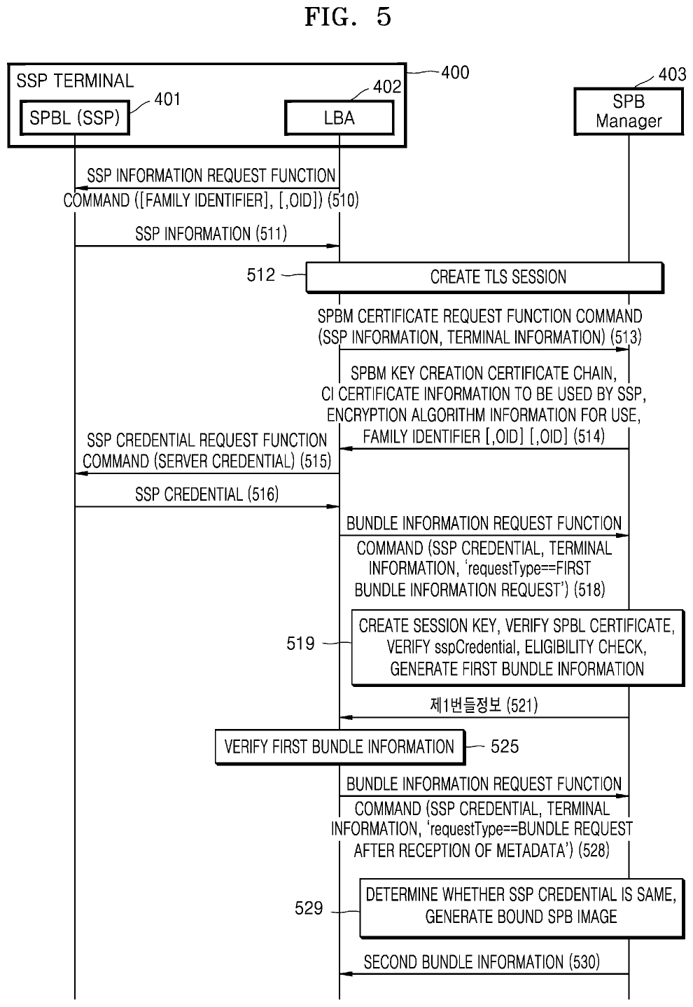

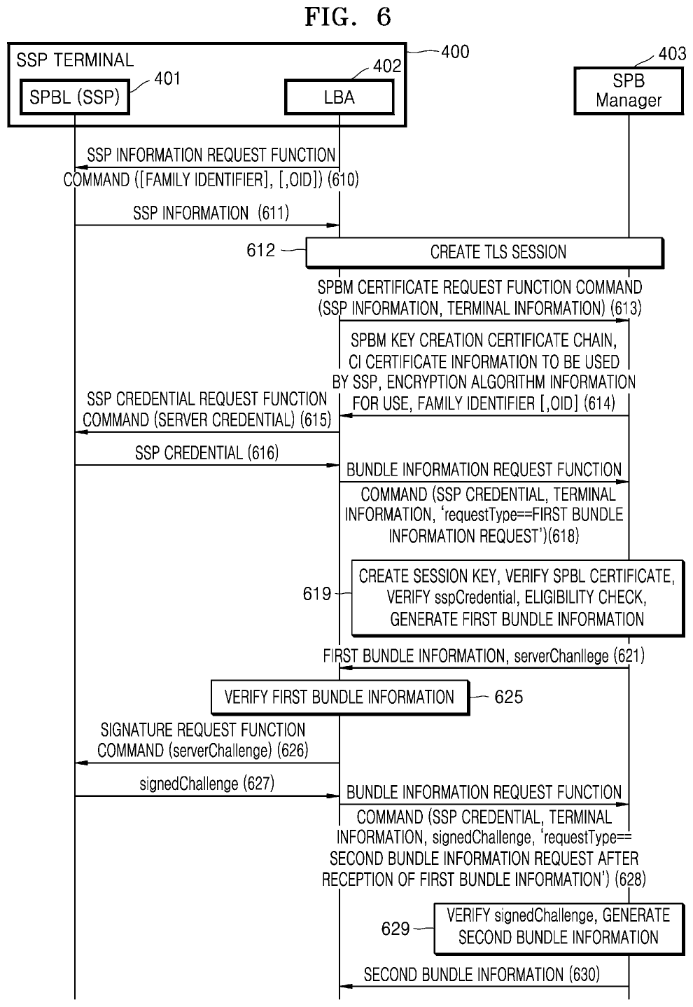

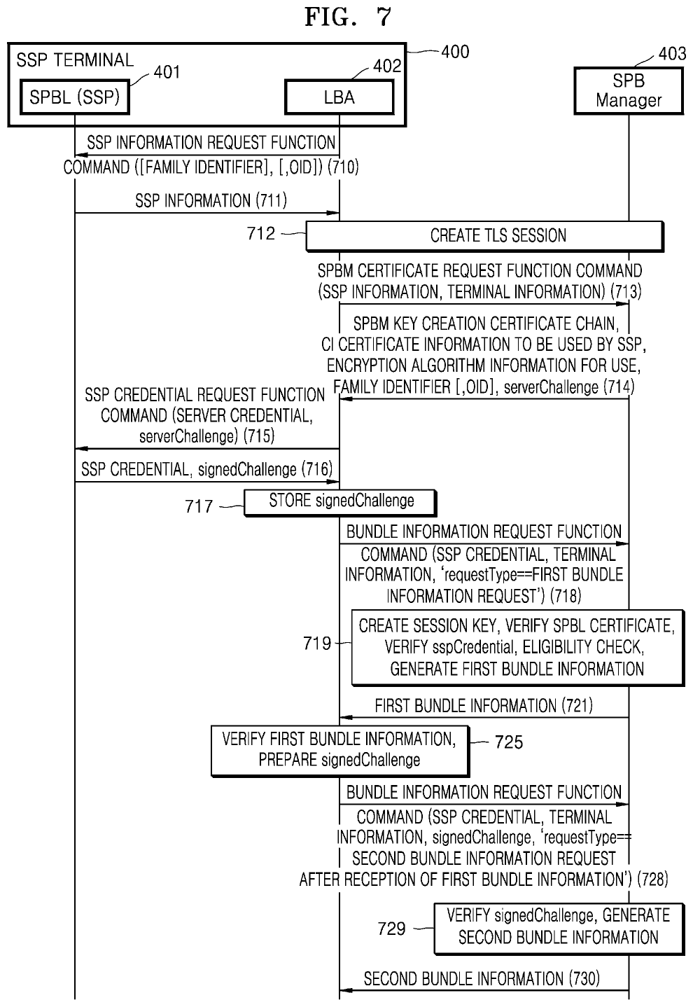

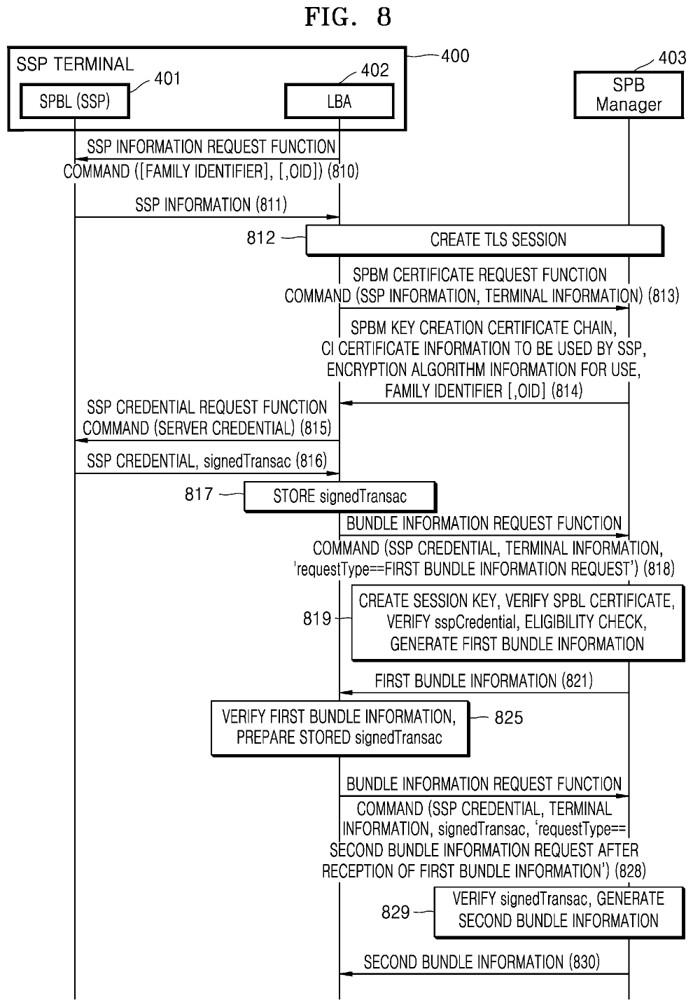

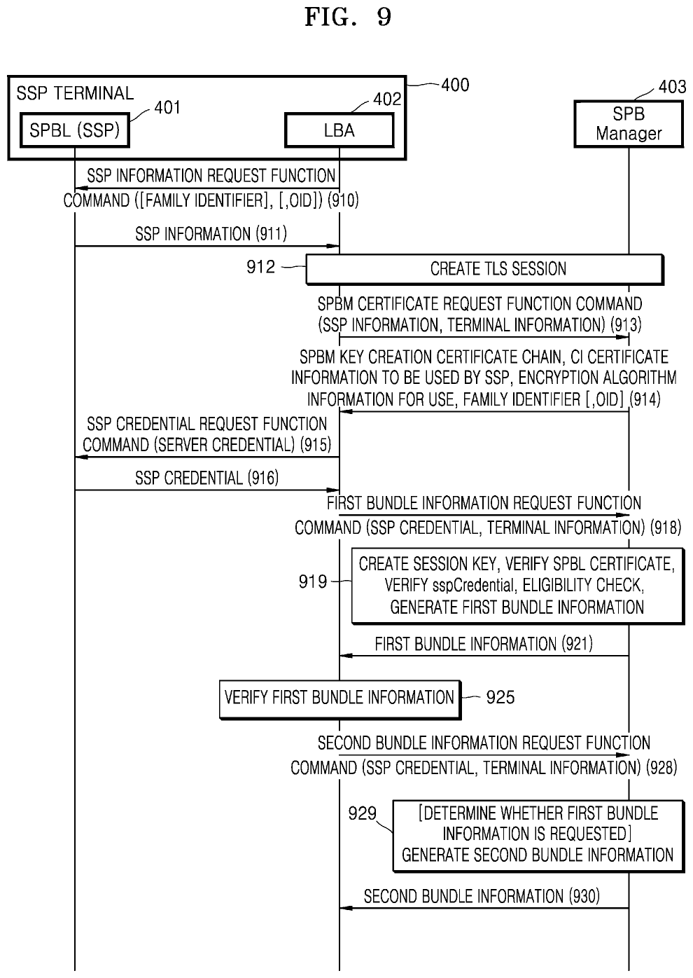

The procedure of determining whether the first bundle information is requested may be the procedure of determining whether the first bundle information is requested, which will be described later at step 529 of FIG. 5, step 629 of FIG. 6, step 729 of FIG. 7, step 829 of FIG. 8, and step of 929 of FIG. 9.

An operation of generating the second bundle information may include at least one of the following steps: (1) creating and encrypting TIME_STAMP with a first session key, (2) creating an SPBM ephemeral key pair (ePK.SPBM.KA, eSK.SPBM.KA) and creating a second session key using the SPBM ephemeral private key (eSK.SPBM.KA) and ePK. SPBL. KA extracted from the SSP credential, (3) selecting an SPBM certificate for signature and prepare a certificate chain, (4) creating an SPBM token including an SPBM ephemeral public key (ePK.SPBM.KA) and a value of ID_TRANSAC in the SSP credential, (5) generating SPBM token signature obtained by signing the SPBM token with a private key corresponding to the SPBM certificate for signature, (6) encrypting an image descriptor, ARP token, segment descriptor structure, etc., with the second session key, and (7) generating second bundle information to be delivered to the terminal. The second bundle information may include data encrypted with the second session key, and second bundle information including an SPBM Token, SPBM Token signature, a bundle segment.

At step 430, the SPB manager 403 may deliver the second bundle information (e.g., bound SPB image) to the LBA 402 in response to the bundle information request function command whose requestType is Type-C or the particular bundle information request function command corresponding to Type-C.

At step 418, the LBA 402 may call a bundle information request function command whose requestType is Type-A (a type requesting the second bundle information) or a particular bundle request function command corresponding to Type-A. Upon reception of the bundle information request function command whose requestType is Type-A or the particular bundle request function command corresponding to Type-A, the SPB manager 403 may perform the following steps: (1) performing step 419, (2) at step 429, skipping the procedure of determining whether the first bundle information is requested and performing a step of generating the second bundle information, and (3) at step 430, responding, with the SBP manager 430, to the bundle information request function command whose requestType is Type-A or the bundle request function command corresponding to Type-A by delivering the second bundle information to the LBA 402.

FIG. 4B is a diagram of a sequence chart illustrating a method of requesting, by an SSP terminal, second bundle information from an SPB manager without separately requesting first bundle information, according to an embodiment.

FIG. 4B shows a partial embodiment of FIG. 4A. Specifically, FIG. 4B shows a sequence chart where the SPB manager 402 generates the second bundle information and responds to the LBA 402 with the second bundle information when the SPB manager 402 receives the bundle information request function command whose requestType is Type-A or the particular bundle request function command corresponding to Type-A at step 418.

Steps 410 to 417 of FIG. 4B may correspond to steps 410 to 417 of FIG. 4A. Step 418b of FIG. 4B is a partial embodiment of step 418 of FIG. 4A, in which when the LBA 402 calls a bundle information request function, it adds requestType indicating Type-A requesting the second bundle information to the bundle information request function command, or it transmits a particular function command corresponding to the second bundle information request including Type-A. Upon reception of the second bundle information request function command corresponding to Type-A at step 418b, the SPB manager 403 may perform step 419. The step 419 may correspond to the step 419 of FIG. 4A. After performing the step 419, the SPB manager 403 may perform step 429b. The step 429b may be a step corresponding to the step 429 of FIG. 4A to generate the second bundle information.

FIG. 5 is a diagram of a sequence chart illustrating a procedure of requesting, by an SSP terminal, a bundle from an SPB manager after receiving first bundle information, according to an embodiment. In particular, FIG. 5 is related to a procedure of determining whether the first bundle information is requested, based on an SSP credential value included in the bundle information request function command in the step 429 as described above with reference to FIG. 4A or 4B.

Previous steps including step 525 in FIG. 5 may be performed as equally as in the corresponding steps of FIG. 4A or 4B.

At step 528, the LBA 402 may transmit a bundle information request function command to the SPB manager 403. At step 528, the LBA 402 may include an SSP credential, terminal information, and requestType in the bundle information request function command. At step 528, a value of the requestType indicates Type-C that requests the second bundle information after receiving the first bundle information.

Upon reception of the bundle information request function command of step 528, the SPB manager 403 may perform a procedure of determining whether the terminal that transmitted the command is equal to a terminal that sent the bundle information request function command at step 418 (a procedure of determining whether the first bundle information is requested). At step 529, the procedure of determining whether the first bundle information is requested may be performed by checking whether an SSP credential and terminal information equal to the SSP credential and terminal information included in the command delivered to request the first bundle information at step 518 is included in the command of step 528.

At step 529, the procedure of determining whether the first bundle information is requested may be simplified to a procedure of determining whether the SSP credential delivered at step 528 is equal to the SSP credential delivered at step 518. At step 529, the procedure of determining whether the first bundle information is requested may be a procedure of performing step 519 with the SSP credential and the terminal Information and determining whether the first bundle information is successfully delivered to the terminal according to step 521.

When it is determined to be the same SSP terminal based on the procedure of determining whether the first bundle information is requested at step 529, the SPB manager 403 may perform the aforementioned step to generate the second bundle information with reference to the step 429 of FIG. 4. When the step to generate the second bundle information is successfully performed, the SPB manager 403 may transmit a response to the bundle information request function command to the LBA 402 by including the second bundle information in the response at step 530.

FIG. 6 is a diagram of a sequence chart illustrating a procedure of requesting, by an SSP terminal, a bundle from an SPB manager after receiving first bundle information, according to an embodiment. In particular, FIG. 6 is related to a procedure of determining whether the first bundle information is requested, by verifying the loader's signature for a challenge value delivered by the SPB manager.

Previous steps including step 619 in FIG. 6 may be performed as equally as in the corresponding steps of FIG. 4.

When the step of the SPB manager 403 is normally performed at step 619, the SPB manager 403 may transmit a response to the bundle information request function command by including the first bundle information and a serverChallenge value in the response at step 621. Upon reception of the response transmitted by the SPB manager 403 at step 621, the LBA 402 may verify the first bundle information at step 625. The LBA 402 delivers a signature request function command to the loader 401 at step 626b after performing step 625. The signature request function command may include serverChallenge received from the SPB manager 403 at step 621.

Upon reception of the signature request function command, the loader 401 generates signedChallenge that is verifiable with a certificate for signature of the loader included in the SSP credential at step 416 based on the serverChallenge value included in the signature request function command and transmits the signedChallenge to the LBA 402 at step 627. The loader 401 may generate the signedChallenge by signing the serverChallenge with a private key corresponding to a public key of the certificate for signature of the loader.

At step 627, the loader 401 may deliver a response to the signature request function command to the LBA 402 by including the serverChallenge and the signedChallenge obtained by signing the serverChallenge n the response.

Upon reception of the response from the loader 401 of step 627, the LBA 402 may request the second bundle information by delivering the bundle information request function command to the SPB manager 403 at step 628. In this case, the bundle information request function command of step 627 may include the signedChallenge received from the loader 401 at step 627. As a way of including the signedChallenge in the bundle information request function command, the signedChallenge may be used for the value of requestType. The serverChallenge may be delivered along with the signedChallenge in the bundle information request function command. The way of using the signedChallenge for the value of requestType may be used as a way to indicate Type-C (a type requesting the second bundle information after requesting the first bundle information).

At step 627, the LBA 402 may not include the SSP credential and terminal information in the bundle information request function command. This is because the SSP terminal that may generate the signedChallenge that may be verified by the SPB manager is one that receives the first bundle information and the serverChallenge as a response to the bundle information request function command previously sent to request only the first bundle information.

At step 629, the SPB manager 403 receives the bundle information request function command and checks requestType included in the command. When the requestType value is Type-C (a type requesting the second bundle information after requesting the first bundle information), the SPB manager 403 may perform a procedure of determining whether the first bundle information is requested. The procedure of determining whether the first bundle information is requested may be a way of verifying the signedChallenge included in the command received by the SPB manager 403. The signedChallenge may be included in the requestType. The SPB manager 403 may verify the signedChallenge included in the bundle information request function command with the public key included in the certificate of the SPBL (loader) verified at step 619. Verification of the signedChallenge may be made by the SPB manager 403 determining whether the signedChallenge is the signature of the serverChallenge value delivered to the LBA 402. That the signedChallenge may be verifiable with a public key included in the loader's certificate is confirming that the loader 401 that generated the SSP credential has signed the serverChallenge sent by the SPB manager 403 to generate the signedChallenge, so the SPB manager 403 may determine that the terminal that transmits the bundle information request function command is equal to the terminal that requests the first bundle information at step 618 (in a procedure of determining whether the first bundle information is requested).

When it is determined to be the same SSP terminal based on the signedChallenge at step 629, the SPB manager 403 may perform the aforementioned step to generate the second bundle information with reference to the step 629 of FIG. 4. When the step to generate the second bundle information is successfully performed, the SPB manager 403 may transmit a response to the bundle information request function command to the LBA 402 by including the second bundle information in the response at step 630.

FIG. 7 is a diagram of a sequence chart illustrating a procedure of requesting, by an SSP terminal, a bundle from an SPB manager after receiving first bundle information, according to an embodiment.

In particular, FIG. 7 is related to a procedure of determining whether the first bundle information is requested, by verifying the loader's signature for a challenge value delivered by the SPB manager.

Previous steps including step 713 in FIG. 7 may be performed as equally as in the corresponding steps of FIG. 4. At step 713, upon reception of the SPBM certificate request function command, the SPB manager 403 may perform the following: (1) perform eligibility check: determining whether the SSP terminal may be supported by checking versions of the LBA and the SPBL, (2) settle a bundle family identifier, (3) optionally settle an object identifier of an organization that manages the bundle family identifier, (4) select an SPBM key generation certificate (CERT.SPBM.KA) and a certificate chain to verify the SPBM key generation certificate, (5) select CI information of a certificate to be used by the SSP, and (6) select encryption algorithm information to be used by the SSP for data encryption.

At step 713, after normally completing the step, the SPB manager 403 may respond with at least one of an SPBM key creation certificate and certificate chain, C information of a certificate to be used by the SSP, encryption algorithm information to be used by the SSP, or a bundle family identifier. The SPB manager 403 may also respond with an object identifier of an organization that manages the family identifier. Furthermore, at step 714, the SPB manager 403 may generate and transmit a serverChallenge value to the LBA 402 in an SPBM certificate request function response. The serverChallenge value may be an octet string that is commonly 16 byte long, which may be randomly generated by the SPB manager 403. Furthermore, the serverChallenge may be used even by a different length of octet string.

The LBA 715 may call an SSP credential request function at step 715 upon reception of the response from the SPB manager 403 at step 714, and transmit an SSP credential request function command to the loader 400. The SSP credential request function command may include a server credential. The server credential may be created as equally as at step 415 of FIG. 4.

Upon reception of the SSP credential request function command at step 716, the loader 401 may create the SSP credential based on a received server credential. The step of creating the SSP credential may correspond to the step of creating the SSP credential at step 416 of FIG. 4. At step 716, the loader 401 may create signedChallenge by signing the serverChallenge included in the SSP credential request function command. The signedChallenge may be generated by signing the serverChallenge with a private key corresponding to a public key of the certificate for the SPBL signature transmitted in the SSP credential. At step 716, the loader 401 may respond to the SSP credential request function command by including the created SSP credential and signedChallenge in the response.

At step 717, the LBA 402 may store the signedChallenge value delivered from the loader 401 at step 716. The signedChallenge value may be used to confirm that it is the same SSP terminal when the LBA 402 requests and receives the first bundle information first and then requests the second bundle information in an ongoing bundle download session.

Steps 718, 719, and 721 of FIG. 7 may correspond to steps 418, 419, and 421 of FIG. 4.

At step 721, upon reception of the first bundle information from the SPB manager 403, the LBA 402 may perform the following steps at step 725: (1) verifying the first bundle information (this step may refer to the step of verifying the first bundle information performed in the step 425 of FIG. 4), and (2) generating a bundle information request function command using the signedChallenge stored at step 717.

The LBA 402 may deliver the bundle information request function command to the SPB manager 403 to download the second bundle information from the SPB manager 403, at step 728. At step 728, the requestType of the bundle information request function command may indicate Type-C (a type requesting the second bundle information after requesting the first bundle information). At step 728, the LBA 402 may use the signedChallenge stored at step 717 as a value of the requestType that indicates Type-C At step 728, the signedChallenge and the serverChallenge may be included together in the bundle information request function command. At step 728, the bundle information request function command may not include an SSP credential and terminal information.

At step 729, the SPB manager 403 may receive the bundle information request function command and check the requestType. When the requestType is Type-C, the SPB manager 403 may perform a procedure of determining whether the first bundle information is requested. The procedure of determining whether the first bundle information is requested may be a way of verifying the signedChallenge included in the bundle information request function command. The signedChallenge may be used for the value of the requestType indicating Type-C. The signedChallenge is verified with the certificate for SPBL signature verified at step 719. Verification of the signedChallenge may be a process of verifying whether the signature of the SSP for the serverChallenge generated by the SPB manager 403 at step 714 matches the signedChallenge by using the certificate for SPBL signature. After verifying whether the signedChallenge is the signature for the serverChallenge transmitted at step 714, the SPB manager 403 generates the second bundle information. The second bundle information may be generated by referring to the step of generating the second bundle information at step 429 of FIG. 4. After completing verification of the signedChallenge and generation of the second bundle information at step 729, the SPB manager 403 may transmit a response to the bundle information request function command to the LBA 402 by including the second bundle information in the response at step 730.

FIG. 8 is a diagram of a sequence chart illustrating a procedure of requesting, by an SSP terminal, second bundle information from an SPB manager after receiving first bundle information, according to an embodiment. In particular, FIG. 8 is related to a procedure of determining whether the first bundle information is requested, by verifying the signature for an ID_TRANSAC value to be used for a session ID included in an SSP credential.

Previous steps including step 815 in FIG. 8 may be performed as equally as in the corresponding steps of FIG. 4A or 4B.

Upon reception of the SSP credential request function command from the LBA 402 at step 816, the loader 401 may create an SSP credential based on a received server credential. At step 816, the loader 401 may create signedTransac by signing ID_TRANSAC generated in the SSP credential creation procedure. The signedTransac may be generated by signing the ID_TRANSAC with a private key corresponding to a public key of a certificate for the SPBL signature included in the SSP credential. At step 816, the loader 401 may respond to the SSP credential request function command by including the SSP credential and the signedIdTransac in the response.

At step 817, the LBA 402 may store the signedIdTransac included in the response received from the loader 401 at step 816. The signedIdTransac value may be used to confirm that it is the same SSP terminal when the LBA 402 requests and receives the first bundle information first and then requests the second bundle information in an ongoing bundle download session.

Steps 818, 819, and 821 of FIG. 8 may correspond to Steps 418, 419, and 421 of FIG. 4.

At step 821, upon reception of the first bundle information from the SPB manager 403, the LBA 402 may perform the following steps at step 825: (1) verifying the first bundle information (this step may refer to the step of verifying the first bundle information performed in the operation 425 of FIG. 4), and (2) generating a bundle information request function command using the signedIdTransac stored at step 817.

The LBA 402 may deliver the bundle information request function command to the SPB manager 403 to download the second bundle information from the SPB manager 403, at step 828. At step 828, the requestType of the bundle information request function command may indicate Type-C (a type requesting the second bundle information after requesting the first bundle information). At step 828, the LBA 402 may use the signedIdTransac stored at step 817 as a value of the requestType that indicates Type-C. At step 828, the signedIdTransac and the ID_TRANSAC may be included together in the bundle information request function command. At step 828, the bundle information request function command may not include an SSP credential and terminal information.

At step 829, the SPB manager 403 may receive the bundle information request function command and check the requestType. When the requestType is Type-C, the SPB manager 403 may perform a procedure of determining whether the first bundle information is requested. The procedure of determining whether the first bundle information is requested may be a way of verifying the signedIdTransac included in the bundle information request function command. The signedIdTransac may be used for the value of the requestType indicating Type-C. The signedIdTransac is verified with the certificate for SPBL signature verified at step 819. Verification of the signedIdTransac may be a process of verifying whether the signature of the SSP for the ID_TRANSAC included in the bundle information request function command received by the SPB manager 403 at step 818 matches the signedIdTransac by using the certificate for SPBL signature. After verifying whether the signedIdTransac is the signature for the ID_TRANSAC received at step 818, the SPB manager 403 generates the second bundle information. The step of generating the second bundle information may correspond to the step of the second bundle information at step 429 of FIG. 4. After completing verification of the signedIdTransac and generation of the second bundle information at step 829, the SPB manager 403 may transmit a response to the bundle information request function command to the LBA 402 by including the second bundle information in the response at step 830.

FIG. 9 is a diagram of a sequence chart illustrating a procedure of requesting, by an SSP terminal, second bundle information from an SPB manager after receiving first bundle information, according to an embodiment. In particular, FIG. 9 is related to an embodiment in which first and second bundle information request function commands exist separately, and the second bundle information is generated following generation of the first bundle information.

Previous steps including step 916 in FIG. 9 may be performed as equally as in the corresponding steps of FIG. 4.

At step 918, the LBA 402 may transmit a first bundle information request function command to the SPB manager 403. The first bundle information request function command may include an SSP credential and terminal information, and the command may be dedicated to requesting the first bundle information and may not include information about a request type (requestType) unlike the previous embodiments of the disclosure.

Steps 919, 921, and 925 may correspond to steps 419, 421, and 425 of FIG. 4.

At step 928, the LBA 402 may transmit a second bundle information request function command to the SPB manager 403. The second bundle information request function command may include an SSP credential and terminal information, and the command may be dedicated to requesting the second bundle information and may not include information about a request type (requestType) unlike the previous embodiments of the disclosure.

Upon reception of the second bundle information request function command at step 928, the SPB manager 403 may perform step 929. At step 929, the SPB manager 403 may perform a procedure of determining whether it is the SSP terminal that has received the first bundle information based on the SSP credential and the terminal information included in the second bundle information request function command. At step 929, the SPB manager 403 may perform the step 919 once again.

In the meantime, when the SSP terminal 400 transmits a second bundle request function command at step 918, the SPB manager 403 may skip the step 921 and perform the step of generating the second bundle information (step 929). The bundle request function command not to perform the step 921 may be defined differently from the second bundle information request function command delivered at step 928.

Step 930 may correspond to the step 430 of FIG. 4A.

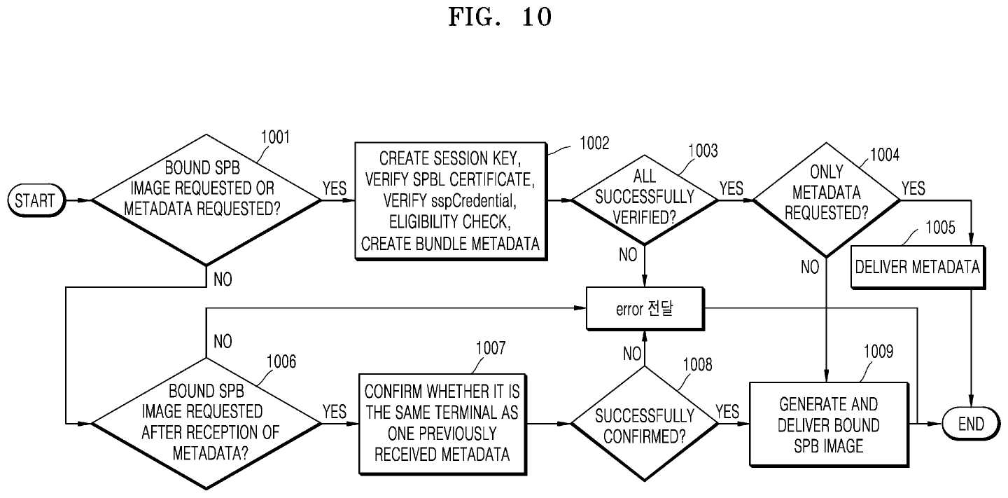

FIG. 10 is a flowchart of an operation of an SPB manager when the SPB manager receives a bundle information request function command in a bundle download procedure, according to an embodiment.

In FIG. 10, the operation of an SPB manager is started by receiving a function command through the Si2 interface, which is an interface between an LBA and the SPB manager. Upon reception of the function command through the Si2 interface, the SPB manager determines whether the received function command is a command to request a bundle or first bundle information, at step 1001. The function command is termed herein a bundle information request function command, and may also be called Si2GetBoundSpbImageCommand, Si2GetBoundSpbImageMetadataCommand, etc. The bundle information request function command may include an SSP credential, terminal information, and requestType.

When the function command received at step 1001 is a bundle information request function command indicating type-A (a type requesting the second bundle information) or Type-B (a type requesting only the first bundle information) as defined at step 418 of FIG. 4, creating a first session key, verifying a certificate for the SPBL signature, verifying the SSP credential, selecting a bundle, checking whether the SSP terminal that has requested to download a bundle may be able to download the bundle, and creating metadata may be performed at step 1002. The step 1002 may correspond to the step performed by the SPB manager at step 419 of FIG. 4.

After normally performing the step 1002, which is checked at step 1003, the SPB manager may check whether the requestType included in the bundle information request command is type-B (the type requesting only the first bundle information), at step 1004. When the requestType is Type-B (the type requesting only the first bundle information), a response including the first bundle information is transmitted to the LBA at step 1005. At step 1005, the SPB manager may include serverChallenge in the response along with the first bundle information. When all of step 1002 is not normally performed, the SPB manager may respond with an error message to the LBA at step 1010.

When the requestType included in the bundle information request command is Type-A (the type requesting second bundle information) at step 1004, the SPB manager generates and responds with the second bundle information to the LBA at step 1009. The step of generating the second bundle information may correspond to the step of generating the second bundle information at step 429 of FIG. 4.

When the received function command includes Type-C (the type requesting the second bundle information after requesting the first bundle information) defined at step 418 of FIG. 4 at step 1006, the SPB manager may perform an operation of confirming whether the terminal that has transmitted the function command is the terminal that has previously requested the first bundle information at step 1007. The confirmation at step 1007 may be performed by one of the following: (1) a procedure of determining whether the first bundle information is requested as at step 529 of FIG. 5: at step 529, the procedure of determining whether the first bundle information is requested may be simplified to a procedure of determining whether the SSP credential delivered at step 529 is equal to the SSP credential delivered at step 518, (2) a procedure of verifying signedChallenge at step 629 of FIG. 6: the SPB manager 403 verifies the signedChallenge included in the received command. The signedChallenge may be included in the requestType. The SPB manager 403 verifies the signedChallenge included in the bundle information request function command with the public key included in the certificate of the SPBL (loader) verified at step 619. Verification of the signedChallenge may be made by the SPB manager 403 determining whether the signedChallenge is the signature of the serverChallenge value delivered to the LBA 402, (3) a procedure of verifying signedChallenge at step 729 of FIG. 7: the signedChallenge is verified with the certificate for SPBL signature verified at step 719. Verification of the signedChallenge may be a process of verifying whether the signature of the SSP for the serverChallenge generated by the SPB manager 403 at step 714 matches the signedChallenge by using the certificate for SPBL signature, and (4) a procedure of verifying signedIdTransac at step 829 of FIG. 8: verify the signedIdTransac included in the bundle information request function command. The signedIdTransac may be used for the value of the requestType indicating Type-C. The signedIdTransac is verified with the certificate for the SPBL signature verified at step 819. Verification of the signedIdTransac may be a process of verifying whether the signature of the SSP for the ID_TRANSAC included in the bundle information request function command received by the SPB manager 403 at step 818 matches the signedIdTransac by using the certificate for SPBL signature.

After successfully performing the verification at step 1007, the SPB manager performs step 1009. When the verification is failed at step 1007, the error message may be transmitted as at step 1010.

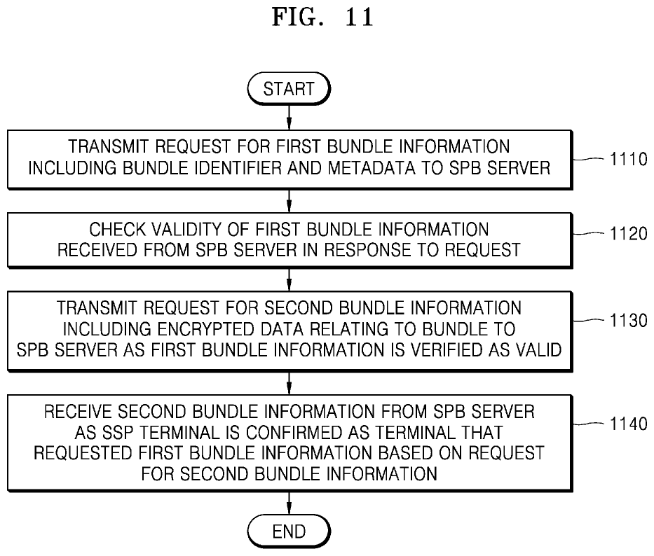

FIG. 11 is a flowchart of an operation of an SSP terminal, according to an embodiment.

At step 1110, the SSP terminal may transmit a first bundle information request including a bundle identifier and metadata to an SPB server. The step 1110 may correspond to each of the step 418, 518, 618, 718, 818, and 918 of FIGS. 4 to 9.

At step 1120, the SSP terminal may check validity of the first bundle information received from the SPB server at the request of the SSP terminal. The step 1120 may correspond to each of the steps 425, 525, 625, 725, 825, and 925 of FIGS. 4 to 9.

At step 1130, the SSP terminal may transmit a second bundle information request including encrypted data relating to a bundle to the SPB server as the first bundle information is verified as being valid. The step 1130 may correspond to each of the steps 428, 528, 628, 728, 828, and 928 of FIGS. 4 to 9.

At step 1140, the SSP terminal may receive the second bundle information from the SPB server as the SSP terminal is confirmed as the terminal that has requested the first bundle information based on the second bundle information request. The step 1140 may correspond to each of the steps 430, 530, 630, 730, 830, and 930 of FIGS. 4 to 9.

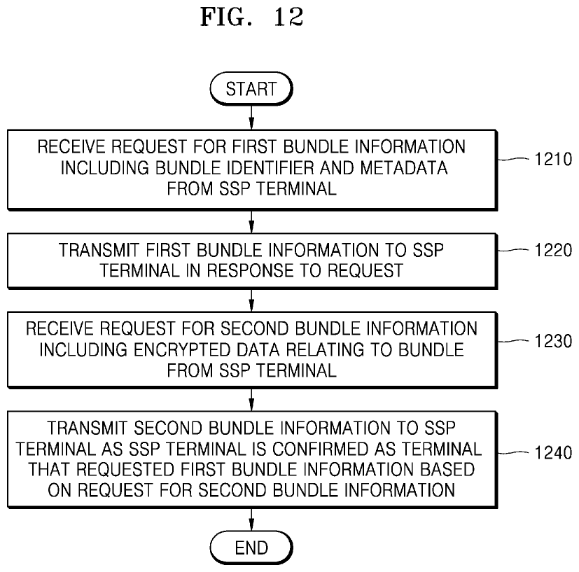

FIG. 12 is a flowchart of an operation of an SPB server, according to an embodiment.

At step 1210, the SPB server may receive a first bundle information request including a bundle identifier and metadata from an SSP terminal. The step 1110 may correspond to each of the steps 418, 518, 618, 718, 818, and 918 of FIGS. 4 to 9.

At step 1220, the SPB server may transmit the first bundle information to the SSP terminal as requested. The step 1220 may correspond to each of the steps 421, 521, 621, 721, 821, and 921 of FIGS. 4 to 9.

At step 1230, the SPB server may receive a second bundle information request including encrypted data relating to a bundle from the SSP terminal as the first bundle information is verified as being valid. The step 1130 may correspond to each of the steps 428, 528, 628, 728, 828, and 928 of FIGS. 4 to 9.

At step 1240, the SPB server may transmit the second bundle information to the SSP terminal as the SSP terminal is confirmed as the terminal that has requested the first bundle information based on the second bundle information request. The step 1140 may correspond to each of the steps 430, 530, 630, 730, 830, and 930 of FIGS. 4 to 9.

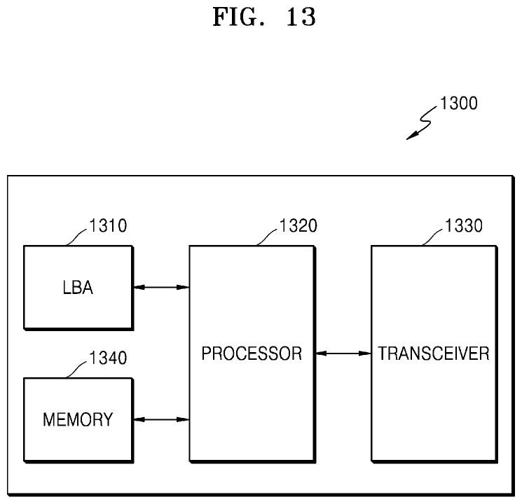

FIG. 13 is a diagram of an SSP terminal, according to an embodiment.

An SSP terminal 1300 may include an LBA 1310, a processor 1320, a transceiver 1330, and a memory 1340.

The LBA 1310 and the processor 1320 may correspond to the LBA and the SSP as described above in connection with FIGS. 1 to 9. The block diagram of FIG. 13 is just an example, and the LBA 1310 may be integrated in the processor 1320.

The transceiver 1330 may transmit or receive signals to or from an SPB server. For this, the transceiver 1330 may include an RF transmitter for up-converting the frequency of a signal to be transmitted and amplifying the signal and an RF receiver for low-noise amplifying a received signal and down-converting the frequency of the received signal.

The memory 1340 may store signals transmitted/received by the SSP terminal, and instructions required to perform the aforementioned steps.

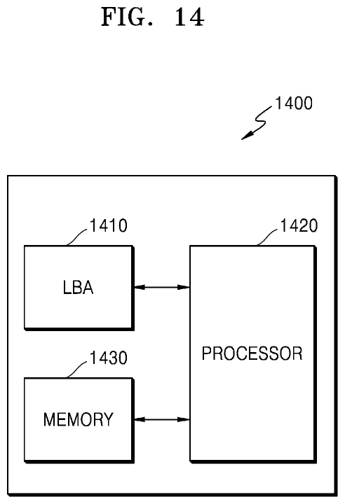

FIG. 14 is a diagram of an SPB server 1400, according to an embodiment.

The SPB server 1400 may include a transceiver 1410, a processor 1420, and a memory 1430.

The transceiver 1410 may transmit or receive signals to or from an SSP terminal. For this, the transceiver 1410 may include an RF transmitter for up-converting the frequency of a signal to be transmitted and amplifying the signal and an RF receiver for low-noise amplifying a received signal and down-converting the frequency of the received signal.

The processor 1420 may control the SPB server 1400 to perform steps of the SPB manager as described above in connection with FIGS. 1 to 9.

The memory 1430 may store signals transmitted/received by the SPB server 1400, and instructions required to perform the aforementioned steps.

The term “module” used herein may represent, for example, a unit including one or more combinations of hardware, software and firmware. The term “module” may be interchangeably used with the terms “logic”, “logical block”, “part” and “circuit”. The “module” may be a minimum unit of an integrated part or may be a part thereof. The “module” may be a minimum unit for performing one or more functions or a part thereof. For example, the “module” may include an ASIC.

Various embodiments of the present disclosure may be implemented by software including an instruction stored in a machine-readable storage media readable by a machine (e.g., a computer). The machine may be a device that calls the instruction from the machine-readable storage media and operates depending on the called instruction and may include the electronic device. When the instruction is executed by the processor, the processor may perform a function corresponding to the instruction directly or using other components under the control of the processor. The instruction may include a code generated or executed by a compiler or an interpreter. The machine-readable storage media may be provided in the form of non-transitory storage media. Here, the term “non-transitory”, as used herein, is a limitation of the medium itself (i.e., tangible, not a signal) as opposed to a limitation on data storage persistency.

A method according to various embodiments disclosed in the present disclosure may be provided as a part of a computer program product. The computer program product may be traded between a seller and a buyer as a product. The computer program product may be distributed in the form of machine-readable storage medium (e.g., a compact disc read only memory (CD-ROM)) or may be distributed only through an application store (e.g., a Play Store™). In the case of online distribution, at least a portion of the computer program product may be temporarily stored or generated in a storage medium such as a memory of a manufacturers server, an application store's server, or a relay server.

Each component (e.g., the module or the program) according to various embodiments may include at least one of the above components, and a portion of the above sub-components may be omitted, or additional other sub-components may be further included. Alternatively or additionally, some components may be integrated in one component and may perform the same or similar functions performed by each corresponding components prior to the integration. Operations performed by a module, a programming, or other components according to various embodiments of the present disclosure may be executed sequentially, in parallel, repeatedly, or in a heuristic method. Also, at least some operations may be executed in different sequences, omitted, or other operations may be added.

While the disclosure has been shown and described with reference to certain embodiments thereof, it will be understood by those skilled in the art that various changes in form and details may be made therein without departing from the scope of the disclosure. Therefore, the scope of the disclosure should not be defined as being limited to the embodiments, but should be defined by the appended claims and equivalents thereof.

What is claimed is:

1. A method of providing, by a terminal, bundle information, the method comprising:
obtaining a smart secure platform (SSP) credential;
transmitting a request command including the obtained SSP credential and a request type for bundle information to a server and
in case that the SSP credential is verified at the server, receiving first bundle information or second bundle information from the server based on the request type,
wherein the first bundle information includes secondary platform bundle (SPB) metadata regarding the second bundle information.

2. The method of claim 1, wherein the receiving comprises:
in case that the request type is determined as a first type, receiving the second bundle information from the server.

3. The method of claim 1, wherein the receiving comprises:
in case that the request type is determined as a second type, receiving the first bundle information from the server,
verifying the received first bundle information;
transmitting a request command for the second bundle information to the server; and
in case that a request type of the request command for the second bundle information is determined as a third type and the request command for the second bundle information is verified at the server based on the SSP credential, receiving the second bundle information from the server.

4. The method of claim 1, wherein the SPB metadata includes a set of custodian specific data corresponding to a family identifier.

5. A method of providing, by a server, bundle information, the method comprising:
receiving a request command including a smart secure platform (SSP) credential of a terminal and a request type for bundle information from the terminal;
identifying the request type for the bundle information from the request command; and
in case that the SSP credential is verified, transmitting first bundle information or second bundle information to the terminal based on the identified request type,
wherein the first bundle information includes secondary platform bundle (SPB) metadata regarding the secondary bundle information.

6. The method of claim 5, further comprising:
in case that the request type is determined as a first type, transmitting the first bundle information.

7. The method of claim 5, wherein the transmitting comprises:
in case that the request type is determined as a second type, transmitting the first bundle information to the terminal,
based on the transmitted first bundle information being verified at the terminal, receiving a request command for the second bundle information from the terminal; and
in case that the request command for the second bundle information is verified at the server based on the SSP credential, transmitting the second bundle information to the terminal.

8. The method of claim 5, wherein the SPB metadata includes a set of custodian specific data corresponding to a family identifier

9. A terminal comprising:
a transceiver; and
a processor configured to:
obtain a smart secure platform (SSP) credential,
transmit, via transceiver, a request command including the obtained SSP credential and a request type for bundle information to a server, and
when the SSP credential is verified at the server, receive, via transceiver, first bundle information or second bundle information from the server based on the request type,
wherein the first bundle information includes secondary platform bundle (SPB) metadata regarding the second bundle information.

10. The terminal of claim 9, wherein the processor is further configured to:
in case that the request type is determined as a first type, receive, via transceiver, the second bundle information from the server.

11. The terminal of claim 9, wherein the processor is further configured to:
in case that the request type is determined as a second type, receive, via transceiver, the first bundle information from the server,
verify the received first bundle information,
transmit, via the transceiver, a request command for the second bundle information to the server, and
in case that a request type of the request command for the second bundle information is determined as a third type and the request command for the second bundle information is verified at the server based on the SSP credential, receive, via the transceiver, the second bundle information from the server.

12. The terminal of claim 9, wherein the SPB metadata includes a set of custodian specific data corresponding to a family identifier.

13. A server comprising:
a transceiver; and
a processor configured to:
receive, via the transceiver, a request command including a smart secure platform (SSP) credential of a terminal and a request type for bundle information from the terminal,
identify the request type for the bundle information from the request command, and
in case that the SSP credential is verified, transmit, via the transceiver, first bundle information or second bundle information to the terminal based on the identified request type,
wherein the first bundle information includes secondary platform bundle (SPB) metadata regarding the second bundle information.

14. The server of claim 13, wherein the processor is further configured to:
in case that the request type is determined as a first type, transmit, via the transceiver, the first bundle information.

15. The server of claim 13, wherein the processor is further configured to:
in case that the request type is determined as a second type, transmit, via the transceiver, the first bundle information to the terminal,
based on the transmitted first bundle information being verified at the terminal, receive, via the transceiver, a request command for the second bundle information from the terminal; and
in case that a request type of the request command for the second bundle information is determined as a third type and the request command for the second bundle information is verified at the server based on the SSP credential, transmit, via the transceiver, the second bundle information to the terminal.

16. The server of claim 13, wherein the SPB metadata includes a set of custodian specific data corresponding to a family identifier.
